(19) United States
(12) Patent Application Publication
(10) Pub. No.: US 2017/0249644 A1
(43) Pub. Date: Aug. 31, 2017

(54) METHODS AND SYSTEMS FOR STORING AND VISUALIZING MANAGED COMPLIANCE PLANS

(71) Applicant: MCS2, LLC, Dublin, OH (US)

(72) Inventors: John P. DiMaggio, Powell, OH (US); Edward N. Stone, Dublin, OH (US)

(73) Assignee: MCS2, LLC, Dublin, OH (US)

(21) Appl. No.: 15/207,469

(22) Filed: Jul. 11, 2016

Related U.S. Application Data
(63) Continuation-in-part of application No. 15/053,991, filed on Feb. 25, 2016.

(51) Int. Cl. G06Q 30/00

(52) U.S. Cl. CPC G06Q 30/018

(57) ABSTRACT

The subject matter described herein includes systems and methods for generating visual representations of data associated with client compliance plans and compliance remediation plans. The systems include implementing a memory to store executable components and a processor that executes components system components including a visualization component configured to display, using a portal executing on a user device, a set of assessment information and the set of remediation information by a set of graphical depictions, a set of numerical depictions and a set of textual depictions based on the current state of compliance as relates to a client compliance plan and client compliance remediation plan.

### PRIORITY CLAIM

This application claims priority to U.S. patent application Ser. No. 15/053,991 filed on Feb. 25, 2016, and entitled “METHOD AND SYSTEM FOR MANAGING COMPLIANCE PLANS”. The entirety of the aforementioned application is incorporated by reference herein.

### TECHNICAL FIELD

This disclosure generally relates to methods and systems for managing compliance plans. In particular, the present invention relates to a method and system for visualizing compliance remediation plans and updates to compliance remediation plans based on processing recurring inputs from a host compliance database and a client compliance database.

### BACKGROUND

Managing compliance with recent healthcare laws and regulations has become an issue for those in the healthcare industry. The Health Insurance Portability and Accountability Act (HIPAA) law was enacted in 1996 and mandates the security and confidentiality of medical patient information and data. The Health Information Technology for Economic and Clinical Health (HITECH) Act was enacted in 2009 and set meaningful use of interoperable Electronic Health Record (EHR) adoption in the health care system as a critical national goal and incentivized EHR adoption.

These laws, and associated regulations promulgated therefrom, are administered by the Office for Civil Rights (OCR) and the Department of Health and Human Services, and apply to all entities covered by the HIPAA and HITECH regulations (Covered Entities) and their Business Associates who have access to protected health information of the Covered Entity. These organizations can include: hospitals, physician provider practices, pharmacies, long term care organizations, homecare, hospice, labs, diagnostic companies, collection agencies, contractors, cloud-based software providers. Entities subject to these laws and regulations are morally and legally obligated to comply with hundreds of complex regulations as well as embrace a continual stream of newly emerging or amended regulations. An entity's failure to comply with applicable laws and regulations can result in sanctions, fines, imprisonment and less of governmental funding for certain organizations participating in the Meaningful Use Incentive Programs.

Federal-funding requirements, and the steep financial penalties affiliated with non-compliance have made the need for comprehensive, recurring and remediated assessments even more critical. Since 2009, breach reporting requirements tied to Meaningful Use incentives have revealed many incidents compromising the personal information of millions of affected individuals. Computer hackers and other data thieves recognize the potential value of an individual's personal information contained in health-care related files, and are constantly searching for new, vulnerable personal data bearing targets.

Keeping current with complex and dynamic regulations intended to safeguard medical patient information is a time-intensive and often ambiguous undertaking for healthcare staff that may already be challenged with an onerous workload. The HIPAA Security Rule alone includes over 60 components that can be measured against over 90 controls established by the National Institute of Standards and Technology (NIST), and these are often both difficult to understand and easily misinterpreted by organization personnel outside of the field. Failure to understand and implement applicable regulations can easily result in non-compliance and a potential breach of protected medical patient data.

Compliance failure can occur if: security and privacy assessments are not performed comprehensively, security and privacy assessments are not performed recurrently, corrective actions are not implemented, corrective actions are implemented incorrectly, required policies and processes are not adhered to consistently, the privacy and security laws are misinterpreted, and/or healthcare personnel are not kept abreast of the ever-changing federal and state laws and regulations governing the privacy and security of personally identifiable healthcare information. There remains a need for a service provided to healthcare clients (Covered Entities and Business Associates) that acts to minimize or eliminate these potential compliance failures relating to host governmental requirements (HIPAA and HITECH Privacy and Security laws and regulations).

### SUMMARY

The following presents a simplified summary of the disclosure in order to provide a basic understanding of some aspects of the disclosure. This summary is not an extensive of the disclosure. It is intended to neither identify key or critical elements of the disclosure nor delineate any scope of the particular aspects of the disclosure, or any scope of the claims. Its sole purpose is to present some concepts of the specification in a simplified form as a prelude to the more detailed description that is presented in this disclosure.

In accordance with an aspect, a system is disclosed comprising a scoring component, a remediation component, a visualization component, a sorting component, and an update component. In an aspect, a scoring component is configured to assign a set of scores to a set of assessment information comprising a set of client data and a set of compliance data, wherein the set of scores are assigned based on a comparison between the set of client data and the set of compliance data, and wherein the set of scores represent a current state of compliance.

Also, in an aspect, a remediation component is configured to generate a set of remediation information in response to the state of compliance, wherein the set of remediation information corresponds to a set of remediation items capable of adjusting a subset of scores of the set of scores to represent an adjusted state of compliance that achieves an increased state of compliance as compared to the current state of compliance. Furthermore, in an aspect, a visualization component is configured to display, using a portal executing on a user device, the set of assessment information and the set of remediation information by a set of graphical depictions, a set of numerical depictions and a set of textual depictions based on the current state of compliance;

In yet another aspect, a sorting component is configured to sort, using the portal executing on the user device, a first subset of assessment information of the set of assessment information according to a set of desired assessment criteria corresponding to the first subset of assessment information and a first subset of remediation information of the set of remediation information based on a set of desired remediation criteria. Furthermore, in an aspect, an update component is configured to update, using the portal executing on the user device, the set of assessment information or the set of remediation information at a reoccurring time interval based on a set of updated assessment information or a set of updated remediation information respectively received by the system.

Also disclosed herein is a method comprising assigning, by a system comprising a processor, a set of scores to a set of assessment information comprising a set of client data and a set of compliance data, wherein the set of scores are assigned based on a comparison between the set of organized client data and the set of compliance data, and wherein the set of scores represent a current state of compliance. The method also includes generating, by the system, a set of remediation information in response to the state of compliance, wherein the set of remediation information corresponds to a set of remediation items capable of adjusting a subset of scores of the set of scores to represent an adjusted state of compliance that achieves greater compliance than the current state of compliance. Furthermore, the method includes displaying, by the system at a portal executing on a user device, the set of assessment information and the set of remediation information using a set of graphical representations, a set of numerical representations and a set of textual representations based on the current state of compliance.

The following description and the annexed drawings set forth in detail certain illustrative aspects of this disclosure. These aspects are indicative, however, of but a few of the various ways in which the principles of this disclosure may be employed. This disclosure intended to include all such aspects and their equivalents. Other advantages and distinctive features of this disclosure will become apparent from the following detailed description of this disclosure when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a non-limiting embodiment of a high-level block diagram of a system that communicates visual representations of data associated with managed client compliance plans in accordance with the subject application;

FIG. 2 illustrates a non-limiting embodiment of a high-level block diagram of a system that communicates visual representations of data associated with managed client compliance plans in accordance with the subject application;

FIG. 3 illustrates a non-limiting embodiment of a high-level block diagram of a system that communicates visual representations of data associated with managed client compliance plans in accordance with the subject application;

FIG. 4 illustrates a non-limiting embodiment of a high-level block diagram of a system that communicates visual representations of data associated with managed client compliance plans in accordance with the subject application;

FIG. 5 illustrates a non-limiting embodiment of a high-level block diagram of a system that communicates visual representations of data associated with managed client compliance plans in accordance with the subject application;

FIG. 6A illustrates a non-limiting embodiment of a high-level block diagram of a system that communicates visual representations of data associated with managed client compliance plans in accordance with the subject application;

FIG. 6B illustrates a non-limiting embodiment of a high-level block diagram of a recurring compliance process;

FIG. 7 illustrates a non-limiting example of a method for communicating visual representations of data associated with managed client compliance plans in accordance with the subject application;

FIG. 8 illustrates a non-limiting example of a method for communicating visual representations of data associated with managed client compliance plans in accordance with the subject application;

FIG. 9 illustrates a non-limiting example of a method for communicating visual representations of data associated with managed client compliance plans in accordance with the subject application;

FIG. 10 illustrates a non-limiting example of a method for communicating visual representations of data associated with managed client compliance plans in accordance with the subject application;

FIG. 11 illustrates a non-limiting example of a method for communicating visual representations of data associated with managed client compliance plans in accordance with the subject application;

FIG. 12 is a schematic block diagram illustrating a suitable operating environment in accordance with various aspects and embodiments;

FIG. 13 is a schematic block diagram of a sample-computing environment in accordance with various aspects and embodiments; and

FIG. 14 illustrates a block diagram of an example, non-limiting operating environment in which one or more embodiments described herein can be facilitated.

### DETAILED DESCRIPTION

The innovation is described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject disclosure is related to systems, methods, and interfaces for storing, managing, visualizing, and accessing compliance plans. In one or more embodiments, a system can include a computer-readable storage media having stored thereon computer executable components, and a processor configured to execute computer executable components stored in the computer-readable storage media. These components can include a scoring, a remediation component, a visualization component, a sorting component, and an update component.

The above-outlined embodiments are now described in more detail with reference to the drawings, wherein like reference numerals are used to refer to like elements throughout. In the following description, for purposes of explanation, numerous specific details are set forth in order to provide a thorough understanding of the embodiments. It may be evident, however, that the embodiments can be practiced without these specific details. In other instances, well-known structures and devices are shown in block diagram form in order to facilitate describing the embodiments.

In implementations, the components described herein can perform actions, in real-time, near real-time, online and/or offline. Online/offline can refer to states identifying connectivity between one or more components. In general, “online” indicates a state of connectivity, while “offline” indicates a disconnected state. In an aspect, offline merging can prevent service interruptions, end-user quality degradation, and the like.

While the various components are illustrated as separate components, it is noted that the various components can be comprised of one or more other components. Further, it is noted that the embodiments can comprise additional components not shown for sake of brevity. Additionally, various aspects described herein may be performed by one device or two or more devices in communication with each other. It is noted that while media items are referred to herein, the systems and methods of this disclosure can utilize other content items.

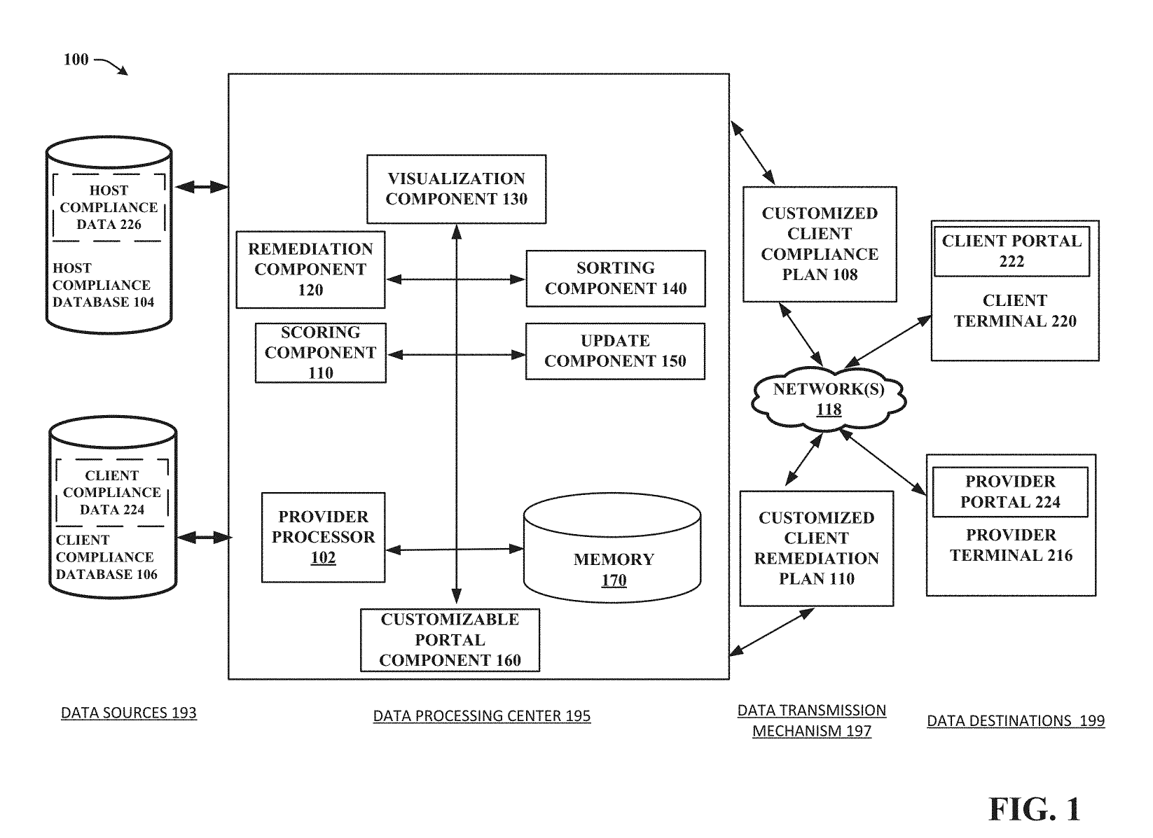

Referring now to FIG. 1, presented is an example system 100 configured to store, manage, facilitate access to, and communicate visualizations of client compliance plans 108 and client remediation plans 110. The various components of system 100 and other systems described herein can be connected either directly or indirectly via one or more networks 118. In an aspect, system 100 includes a network 118 that can include wired and wireless networks, including but not limited to, a cellular network, a wide area network (WAN, e.g., the Internet), a local area network (LAN), or a personal area network (PAN). For example, a provider processor 102 can communicate with a network resource 116 (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks. In an aspect, a provider terminal 216 (e.g., computer device, server device, etc.) of system 100 can communicate (e.g., using network 118) with processor 102 (also referred to as provider processor 102) and memory 170 that stores computer executable components, and provider processor 102 executes the computer executable components stored in the memory 170. For example, one or more of the components employed by provider processor 102 can be stored in memory 170.

Furthermore, system 100 employs a memory 170 that stores executable components; and a processor 102, communicatively coupled to the memory 170, the provider processor 102 is configured to facilitate execution of the executable components, the executable components comprising: scoring component 110, remediation component 120, visualization component 130, sorting component 140, and update component 150. In an aspect, scoring component 110 is configured to assign a set of scores to a set of assessment information comprising a set of client data and a set of compliance data, wherein the set of scores are assigned based on a comparison between the set of client data and the set of compliance data, and wherein the set of scores represent a current state of compliance.

In an aspect, client compliance data 224 (also referred to as client data 224) and host data can be accessed from a client database 106 (also referred to as client compliance database 106) and a host database 104 (also referred to as host compliance database 104), wherein a set of first client compliance data represents a first set of information for compliance evaluation, and wherein the set of first host data represents a first set of compliance requirements. The compliance relates to an entity's success or failure to comply with applicable healthcare, privacy, and security laws, regulations, procedures, controls, best practices, policies, organization specific compliance criteria, and processes; where failure to comply can, in some instances, result in sanctions, fines, imprisonment, and possible loss of governmental funding (e.g., for organizations participating in Meaningful Use Incentive Programs).

As such, system 100 facilitates the ability for an entity (e.g., hospital, physician, provider practice, pharmacy, long term care organization, homecare, hospice, lab, diagnostic company, collection agency, contractor, software provider, etc.) to conduct comprehensive, recurring and remediated assessments of each entity's compliance with regulations and laws (e.g., HIPAA and HITECH Privacy and Security laws and regulations, NIST references, security controls, etc.). Furthermore, system 100 (and other embodiments disclosed throughout this disclosure) facilitate the comprehension, management, analysis, evaluation, and visualization of the states of compliance of a client and associated attributes of such states of compliance.

Accordingly, a user can utilize system 100 to interact with compliance data (e.g., that includes client data, host data, and client data analyzed together with host data in blended formats) and remediation data as pertains to its own business goals and objectives. In an aspect, compliance data points can be altered, reconfigured, combined and visualized in numerous formats to allow a client to understand its state of compliance and undertake actions or preparations to achieve greater compliance or more effective compliance with regulations, laws, controls, and other such administrative regimes.

Thus to accomplish the goal of satisfying various compliance requirements related to client business objectives, system 100 employs scoring component 110 that assigns compliancy scores to various subsets of client compliance data 224 retrieved from client compliance database 106, host data from host compliance database 104, client compliance plan 108 items and tasks, and client remediation plan 110 items and tasks. For instance, the client compliance data 224 can relate to a client's compliance with healthcare laws and regulations such as HIPAA and HITECH Privacy and Security compliancy. The host data can include data relating to governmental compliance requirements, healthcare laws, regulations, controls, best practices and other such compliance standards. The host compliance database 104 and the client compliance database 106 can each respectively comprise data assorted by categories, sub categories, meta data, contextual data, content data (e.g., associated with a report), portal data (e.g., associated with a report) and other such data classifications. In a non-limiting instance, scores can be assigned (e.g., using scoring component 110) to a first set of client data (e.g., client data representing security protocols, procedures, policies, etc.) or the client compliance data 224 as compared to pertinent host data (e.g., HIPAA policies, rules, regulations, and processes).

In an aspect, a customized client compliance plan 108 can include a comparison of data inputs (e.g., host data and client compliance data 224) by provider processor 102 in relation to a client's goals. The customized client compliance plan 108 can also represent a current state of compliance at a given moment in time with respect to the first set of information as compared to the set of first compliance requirements and a set of pertinent client objectives. In another aspect, the customized client compliance plan 108 can communicate the current activities underway, resource allocations, compliance items conducted, and state of compliance relating to such activities, resource allocations, and other compliance items.

As such, the customized compliance plan 108 can convey a status related to a client's policy data, process flow data, technical flow data, environmental structure data, administrative flow data, technical flow data, physical flow data, or organizational data. Also, scoring component 110 can assign scores to each subset of data representing states of compliance for each subset of data. Furthermore, the client compliance plan 108 can be evaluated based on an aggregation of assigned scores (e.g., using scoring component 110) corresponding to each subset of data to determine a general state of compliance of the client's compliance program.

In another aspect, scoring component 110 can assign a set of scores to client compliance data 224 as compared to host compliance data 226 based on various criteria such as a client's ability to satisfy compliance plan items, missing items needed for compliance, compliance of subsets of data to security status rules/controls/processes (e.g., NIST, HIPAA), vulnerabilities with a client's compliance program, vulnerability mitigation mechanisms and types currently implemented, severity of current vulnerabilities, occurrence of and frequency of occurrence of vulnerability exploitation, absolute quantity of issues and localities associated with such issues, ranking of issues incurred or ongoing (e.g., by severity), detailed analysis associated with each issue, tasks underway to remediate unmet compliance requirements or fully implement current compliance programs, priority of tasks, metrics associated with task tracking, evaluation of privacy breaches, and other such scoring factors.

Accordingly, scoring component 110 can assign a score to the compared client data and host data based on sub-scores for various categories, policies, processes, procedures, technical structures, and environmental structures of the client business, where the sub-scores can be determined based on factors such as those described above (e.g., vulnerabilities, mitigation techniques, task types, etc.). For instance, scoring component 110 can assign a score to evaluate categories in the administrative, technical, physical and process flow categories of the client. An administrative flow category can include data representing policies, procedures, contracts, and training of an organization.

Generally, a physical flow category can include data representing physical controls of the client such as screen locations, monitors, access to secure areas, and other such physical attributes of the organization. A technical flow category can include data representing the technical environment, vulnerability scans, technology tools, and configuration information of a client. A process flow category represents data associated with the collection, storage and transmission of Electronic Protected Health Information (EPHI). An administrative flow category represents data relating to policies, procedures, contracts, and training.

In an aspect, scoring component 110 can assign a score to each category to represent a portion of the state of compliance of the client. For instance, scoring component 110 can assign a score to items within the physical flow category and thus a first item score can be assigned to a screen location of the company screens based on a comparison to the host data set that represents the regulatory standard for screen locations (e.g., screens located in an area where only an authorized user can view them). A second item score can be assigned (e.g., using scoring component 110) to the physical flow item addressing secure areas based on a comparison between the client's secure areas (e.g., at client's office) and the regulatory standard proscribing the constitutional make-up of a secure area (e.g., biometric security authorization required to access the secure area).

In a non-limiting example, if a client has an office layout that exposes PHI to security vulnerabilities then a compliance requirement related to the protection of PHI may be assigned a score that indicates an issue or technique associated with a client's physical flow requires remediation or further compliance safeguards. Thus, if a computer monitor used to display public information is within view of the public or is accessible to the public (e.g., lacking a screen lock, password, encryption technology, door lock to the office, etc.) then remediation of the physical layout of equipment and/or office may be a solution to remediating such issue.

Furthermore, in an aspect, scoring component 110 can assign a score to each category. For instance, a first category score can be assigned to the physical flow category of the client, where the first category score is determined based on a number of assessment factors including the items scores (e.g., first item score and second item score). Also, scoring component 110 can assign scores to the client based on regulation compliance and control compliance. For example, a regulation score can represent a clients' state of compliance with regulatory standards set forth by various regulations and regulatory bodies. Similarly, a control score can represent a clients' state of compliance with recommended processes and procedures (e.g., NIST Controls).

As a non-limiting example, processor 102 generates (e.g., by employing scoring component 110) a customized client compliance plan 108 based on the clients' organization specific objective and based on a comparison between client data and host data. As such, scoring component 110 can use host data representing NIST references from host compliance database 104 to compare customized client compliance plan 108 against HIPAA Security Rules and Security Controls (e.g. a first subset of host data). In an aspect, processor 102 employs scoring component 110 to assign compliancy scores for each relevant HIPAA Security Rule and Security Control based on respective comparisons between each security rule and each associated client activity governed by such rule or control.

In another aspect, each score (e.g., item compliancy score, category compliancy score, and other such compliance scores) can be assigned a rating (e.g., using scoring component 110) of “compliant”, “needs improvement” or “non-compliant” based on the compliancy score. In an aspect, the score, assigned to a client representing a client compliancy with rules and regulations such as HIPPAA, can consider various organization specific parameters to facilitate a determination of client compliancy.

In another aspect, system 100 can employ remediation component 120 configured to generate a set of remediation information in response to the state of compliance, wherein the set of remediation information corresponds to a set of remediation items (also referred to as compliance items requiring remediation) capable of adjusting a subset of scores of the set of scores to represent an adjusted state of compliance that achieves an increased state of compliance as compared to the current state of compliance. In an aspect, a client compliance remediation plan 110 (e.g., also referred to as remediation information) can be generated (e.g., using remediation component 120) in response to the state of compliance as determined from a comparison of the client data and the host data as well as the scoring.

The client compliance remediation plan 110 can indicate deficiencies in the client compliance plan 108 or current state of client compliance based on a deficiency analysis (e.g. performed by components employed by processor 102). The client compliance remediation plan 110 (also referred to as client remediation plan 110) can identify a deficiency, if applicable, for each Security Rule and Security Control. For instance, each item or category rated as “Needs Improvement” of “Non-Compliant” relative to the client compliance plan 108 can indicate deficiencies and proscribe remedies (as per the client compliance remediation plan 110) to improve the compliance status of the client. In an aspect, the client compliance remediation plan 110 can be presented and accessed by a client via a client portal 222. The client portal 222 is accessible through network 118 and can provide communication between data, reports, software elements and a provider terminal 216 and client terminal 220, which can display data, reports, compliance plans, remediation plans, and other such information. In an aspect, data can be populated into each respective database or data warehouse and from each respective database to various system 100 components (e.g., memory 170) on an ongoing basis, such as continually, periodically, or from time to time.

In an aspect, the client compliance remediation plan 110 can include a list of recommendations to the client that may improve its security and privacy compliancy. Furthermore, the client compliance remediation plan 110 can also include a recommendation approach plan that outlines best practice remediation steps, as well as a Gantt Chart outlining a Plan of Action and Milestones to implement the remediation plan. The list of recommendations to improve compliancy can be displayed in a prioritized manner. For instance, the list may enumerate items based on those items that pose the highest risk of security or privacy breaches. Furthermore, in an aspect, the remediation plan may also include target completion dates for compliance items or remediation steps. The target completion dates can be prioritized based on client resource availability, urgency of the item, resource (e.g., cost, time, manpower, etc.) allocation required to comply with the item, and other such prioritization factors.

In yet another aspect, system 200 can employ visualization component 130 that is configured to display, using a portal 222 executing on a user device, the set of assessment information and the set of remediation information by a set of graphical depictions, a set of numerical depictions and a set of textual depictions based on the current state of compliance. In an aspect, system 200 facilitates client access to information including the state of compliance, remediation plan, compliance data, client data, and other aspects of the clients' compliance regimen through a client portal 222. In an aspect, the client portal 222 is accessible through network 218 and the client portal 222 can be accessed via a client terminal 220 (e.g., a computer, tablet, smartphone, personal digital assistant, etc.). Furthermore, the client portal 222 can be accessed via the provider 114 at provider terminal 216. In an aspect, a customizable portal component 160 is a system 100 component that allows for clients and associated users with privileges to access corresponding user interfaces (e.g., on client terminal 220 and customized portals (e.g., client portal 222). The customizable portals function as private websites to view and publish data associated with compliance plans and remediation plans (e.g., using visualization component 130).

In an aspect, the provider 114 can provide numerous portals (e.g., a portal for each client, a portal for the provider, etc.) each portal for a different unique client 112. Accordingly, each portal can deliver dynamic content to each client 112, where the content specifically relates to the respective clients' compliance plan 108, client remediation plan 110, compliance data, client data, and other such compliance related content. The client portal 222 also allows permitted users to access the content such that a number of employees from an organization can access their company's portal, view the information, and collaborate with other authorized users. Also, each user accessing the portal 222 can possess various respective privileges and each portal 222 can be customized to allow and restrict such privileges. Thus, for instance a CEO of a company can access portal A, operational employees can access portal B and portal C with viewing limitations or privileges, and employee responsible for implementing a compliance regiment or remediation plan can access portal D, members of a compliance committee within an organization can view portal E with its own set of privileges and limitations and so on.

A user accessing the portal can do so via a local network or a global network depending on whether the user is a local user or remote user. Also, a user (e.g., visitor) accessing the client portal 222 can do so through network 118 using a browser. Furthermore, the portal can allow for administrative users to possess administrative capabilities such as publish content, completed compliance tasks, additional compliance tasks, specify the level of control other logged-on users have, and perform other such administrative activities. The portal also allows for users to interact with the compliance data using a portal interface that presents the compliance data. Furthermore, the provider can access a provider portal 224 to perform provider services related to each client.

In an aspect, system 200 employs visualization component 130 to present various depictions of the compliance data based on compliance activities. For instance, the compliance data is dynamic in that it is continuously updated. The client data is continuously updated with new tasks, changes in existing tasks, and revisions to compliance plans. Also, host data is continuously updated to reflect new regulations, new controls, revisions to existing controls and regulations, as well as changes to best practices and other host compliance data.

In light of the dynamism of the data associated with the compliance plans, visualization component 130 facilitates the presentation of information in dynamic formats and depictions representative of new comparisons, algorithms, calculations, and determinations associated with the healthcare compliance regimens of various clients. In an aspect, the presentation options can be presented to the user on a graphical user interface (GUI). The GUI can provide presentation options to facilitate a user to consume summary information, trend information, activity information and other such information associated with the client compliance activities and remediation activities. As such, visualization component 130 can display charts, graphics, texts, and other such formats of the compliance data to facilitate user comprehension of their current state of compliance, path to future remediation, and updated state of compliance. For instance, the National Institute of Standards and Technology (NIST) developed national guidelines to improve the efficiency and effectiveness of information technology, planning, implementation, management, and operations related to security and privacy-related information that each client possesses.

Each client can access client portal 222 to view information related to its respective compliance with NIST statutory responsibilities, standards, processes/procedures (e.g., NIST Special Publication 800-66 rev 1), controls (e.g., NIST 800-53), guidelines, requirements for information technology related activities. Thus, if a client is developing information security technologies for its consumer (e.g., patient) information, then they should consider in its development the implementation of safeguards and countermeasures to minimize security potential risks in accordance with NIST processes.

Furthermore, the client should take into account various security control categories in the development of its security technology including, but not limited to; AC Access Control; AT Awareness and Training, AU Audit and Accountability, CA Certification, Accreditation, and Security Assessments, CM Configuration Management, CP Contingency Planning, IA Identification and Authentication, IR Incident Response, MA Maintenance, MP Media Protection, PE Physical and Environmental Protection, PL Planning, PS Personnel Security, RA Risk Assessment, SA System and Services Acquisition, SC System and Communications Protection, SI System and Information Integrity, and PM Program Management.

As such, by accessing the portal 222, the client can view various compliance data related to the NIST security family indicators. Furthermore, system 200 can employ visualization component 130 to display depictions of the compliance data such as NIST security status information in a variety of display formats. For instance, a visualization component 130 can facilitate display of the general NIST security status that represents the fulfillment of NIST standards, controls, procedures, processes and other such NIST proscriptions. In an aspect, the display can include a graphic representation of the general scope of meeting such NIST requirements such as in a pie chart (or other such chart) that indicates whether the NIST requirements have been fulfilled (e.g., met), unfulfilled (e.g., not met), or partially fulfilled (e.g., partially met). The visual depiction can be presented as a percentage of total NIST items for fulfillment of as an absolute number of items fulfilled, unfulfilled or partially fulfilled, and other such information representations.

The visual depiction displayed (e.g., using visualization component 130) can be linked to a data source (e.g., host database, client database) and data points within the database (host data, client data, compliance data, remediation data, etc.) which can be continuously updated and changed in a dynamic manner. Thus the visualizations of the data points are dynamic and can accommodate the incorporation of updates and changes in status of the items reflected by data changes. Furthermore, visual depictions displayed can be tied to weighting, algorithms, variables, constants and other such mechanisms that can cause changes and updates to the compliance data and therefore alter the visual depictions (e.g., using visualization component 130) as well as client compliance plans 108 and client remediation plans 110.

For example, the NIST Security Status pie chart can be revised in real-time to reflect new procedures, controls, and regulations that are moving from being not met to becoming partially met (e.g., if the client has commenced performing compliance activities to satisfy the NIST item compliance requirement), moving from partially met to met, or moving from partially met or met to not met (e.g., if the client discontinues a compliance practice). The pie chart can reflect such changes in the compliance data and inform the portal user of the most current and up to date state of compliance using such visual information. Also, tabular visualizations capable of scrolling, searching, editing, and mapping can be updated with new data points and changing data points.

Furthermore, in an aspect, other such forms of visualization can take effect such as depictions of NIST security families in bar chart formats. For instance, a client user is capable of visualizing and understanding its compliance state as related to NIST security families where an X-axis can present NIST Security family categories such as risk assessment, planning, physical security, personnel security, and those families that are not applicable. The Y-axis of the bar chart can display the number of items within such NIST family (e.g., 3 risk assessment items, 3 planning items, 9 physical security items, etc.). As such, the data can be sliced in and displayed (e.g., using visualization component 130) in different presentation formats to effectively communicate various client compliance states. Also, the particular NIST compliance standard being assessed can be broken down into code identifiers associated with a particular compliance item as well as the category that it falls within.

As such, the NIST security compliance items can cover access control items such as Wireless Access (e.g., code AC 18), Visitor Control (e.g., code PE 7), User Identification and Authentication (e.g., code IA 2), User of Cryptography (e.g., code SC 13), Transmission Integrity (e.g., code SC 8), Transmission Confidentiality (e.g., code SC 9), Time Limit (e.g., code N/A), Third Party Personnel Security (e.g., code PS 7), Telecommunications Services (e.g., code CP 8), and other such NIST security compliance items. Each item can represent data points that are fed into the NIST Security Family information and the NIST Security Status information as well as visual depictions of the information. Furthermore, such data points can contribute to scoring regimes that associate with compliance remediation plans and client compliance plans.

Similarly, visualization component 130 can facilitate the graphical and textual depictions of a clients' compliance with HIPAA regulations. For instance, visualization component 130 can employ graphical depictions of data representing HIPAA regulatory compliance states of a client. As such, a client can retrieve graphical or textual information reciting whether its HIPAA regulatory requirements are “partially met”, “met”, or “not met” as well as the quantification of how much it is met, not met, or partially met (e.g., number of items under each category). Furthermore, a client can view HIPAA safeguard family information in bar chart format (or other graphical and textual formats), such that the Administrative, Organizational, Physical, and Technical organizational items can be comprehensively understood by displaying a number of items within each family category required for compliance (whether or not “met”, “partially met”, or “not met”).

Also, the particular HIPAA compliance standard being assessed can be broken down into code identifiers associated with a particular compliance item as well as the category that it falls within. For a non-limiting example, each HIPAA rule and associated HIPAA Policy can be viewed (via scrolling). Thus, compliance safeguards related to a clients' Workstation Use (e.g., HIPAA Rule No. 164.310(b)), Workstation Security (e.g., HIPAA Rule No. 164.310(c)), Workforce Security (e.g., HIPAA Rule No. 164.308(a)(3)(i)), Workforce Clearance Procedure (e.g., HIPAA Rule No. 164.308(a)(3)(ii)(B)), Updates (e.g., HIPAA Rule No. 164.316(b)(ii) Update), Unique User Identification (e.g., HIPAA Rule No. 164.312(a)(2)(i)), Transmission Security (e.g., HIPAA Rule No. 164.312(e)(1)), Time Limit (e.g., HIPAA Rule No. 164.316(b)(2)(ii)time), Testing and Revision Procedures (e.g., HIPAA Rule No. 164.308(a)(7)(ii)(D), and Termination Procedures (e.g., HIPAA Rule No. 164.308(a)(3)(ii)(C)) are all easily identified by the client using scrollable lists of each item and other such HIPAA rule items.

In yet another aspect, visualization component 130 can depict vulnerability data related to a compliance state of the client and client processes, activities and operations. In an aspect, the visual depiction (e.g., bar chart) of such vulnerability data can represent various stages of vulnerability including high, info., low, and medium vulnerability stages and furthermore, each vulnerability stage can be quantified. Also, efforts to mitigate outstanding vulnerabilities can be depicted (e.g., in bar charts, pie charts, graphs, etc.) and characterized via visual displays. As such, types of mitigation efforts can include configuring various vulnerabilities, implementing security updates within the clients' business and systems, and other such vulnerability mitigation activities. In another aspect, clients can scroll through various vulnerability items to comprehend the areas that are evaluated for compliance. For instance, vulnerability items can include aspects of account lock-outs, account lock-out reset times, additional LSA protections not configured, adobe acrobat multiple vulnerabilities, and other such vulnerabilities.

The vulnerabilities as a whole can also be represented in forms of severity, mitigation types, incurred exploitation of such vulnerabilities, and other such characterizations and calculations related to the vulnerability data. In an instance, visualization component 130 can display a depiction of the severity of vulnerabilities to the clients' security and compliance program. The vulnerability severity can include an assessment of areas of high, medium, and low vulnerability as well as information vulnerabilities.

Furthermore, such vulnerabilities can be depicted in a chart or graphic display (e.g., pie chart) to provide an easier user comprehension of the vulnerability severity. The vulnerability severity can also be displayed in a scrollable table format such that columns can identify the vulnerability, the respective IP addresses, the software asset, and other such vulnerability severity information. For example, vulnerabilities can include account lock out's (e.g., client lock-outs), account lockout reset times, and other such vulnerability severity items. As such, users can scroll through vulnerability items and assess the severity of each respective item's outstanding vulnerability.

Furthermore, to combat vulnerabilities to the clients' compliance program, each client can implement various mitigating items. The client can access the portal and view mitigation types presented using visualization component 130 in various formats including bar charts. For instance, the mitigation types can include security updates, configurations, and other mitigation items. Also, regarding vulnerabilities, the portal can display visualizations (e.g., using visualization component 130) depicting the occurrence of vulnerable item exploitation and the lack of occurrence of vulnerable item exploitation to quantify the number of items exploited versus not exploited within the client's compliance program.

In some instances, a client 112 may service a variety of different consumers or same consumers situated at numerous locations. Accordingly, the client is also able (e.g., using the portal) to view the respective locations of consumers as well as the corresponding locations with compliance issues. For instance, the visualization component 130 can display (at the portal interface) a list of the names of consumers (e.g., Hospital A, Patient B, Private Practice C, Surgical Center D, Rheumatoid Arthritis Clinic E, Industry Organization F, Parent Company G, etc.) and in a corresponding column present the location of such consumer (e.g., Location A, Region B, City C, etc.). Furthermore, visualizations can be provided of comparative analytics (e.g., of industry organizations) based on analytics items such as peer scoring, common issues within a group, meeting set thresholds for a group and other such analytical items. In addition to a scrollable table format, the locations with issues can also be organized in bar chart form with various parameters or variables pertaining to compliance item issues being depicted on the X-axis or Y-axis and the other axis comprising the location of interest. Furthermore, the locations can be listed as a heat map, cluster map, or other sort of map to observe trends as to which locations are experiencing more compliance issues and to identify which compliance issue items a recurring (e.g., frequently occurring) or isolated (e.g., outliers), where this is occurring, and other such location-based trends.

Also, in an aspect, particular processes, controls, or regulations can be viewed (e.g., using visualization component 130) in isolation to observe and identify trends occurring on a more narrowly defined scale. For instance, the NIST issues can be outlined in a format that ranks the top NIST issues, most easily complied with NIST issues, the most frequently occurring NIST issues, and other such NIST issue trends. The issues can also be detailed in multiple formats (e.g., scrollable table, chart, graphic, etc.).

For example, the issue details can be itemized with brief descriptions such as in the case of physical security issues, the items can include; keys secured, closets and workspaces free of documents and files containing protected health information (PHI), access and authorization, delivery and removal of records, doors locked or monitored to secure areas, secure systems with access to electronic health records (EHR), closets and workspaces free of documents and files containing PHI, locks changed, monitors not visible, and other such item compliance or security information.

Furthermore, in an aspect, the issues can include observational details in columns adjacent to the item to expound on the compliance issue and/or remediation task. For instance, the item referenced as “keys secured” can present an observation in the adjacent column that each employee has a unique alarm code and that each employee possesses their own key. Also, the item referenced as “doors locked” can present a corresponding observation that the room where IT infrastructure equipment is located is not locked or has no locks. Accordingly, the item itself represents an item that is governed by a process, control, regulation, or law. As such, the observation can detail the circumstance of the client that either sheds light on the client's achievement of the compliance requirement, partial achievement, or lack of achievement of compliance as pertains to the item. This information can facilitate a client user to better understand where they stand on compliance at a granular item level and comprehend how it needs to change its processes, activities, environment or other business related mechanism to address the item.

In another aspect, visualization component 130 can depict via visualizations compliance data representing various tasks to be performed related to achieving compliance or remediating compliance issues. For instance, task groups can be presented in chart format (e.g., bar chart, pie chart, line graph, etc.) to display information as to how many of a group of tasks are active tasks (e.g., tasks completed or actively being performed), on-deck tasks (e.g., high priority or next in line tasks to be performed), or ongoing tasks (e.g., tasks performed on a continual basis but not yet complete). Furthermore, the tasks can be prioritized and depicted in chart format as to the priority of the task (e.g., on a scale of 1 to 100) and the number of high priority tasks, moderate priority tasks, and/or low priority tasks.

Also, the tasks can be isolated by family such as NIST family or HIPAA family and multiple parameters can be modeled in a single chart (e.g., moderate tasks, and high tasks per family). For instance, a chart can monitor various NIST tasks that are monitored, assessed, or evaluated, such as planning, access control, contingency planning, physical security, personnel security, incident response, audit, identification, integrity, media protection, assessment, awareness training, cryptography, maintenance, risk assessment, acquisition, and other such NIST families. Furthermore, the NIST task families can be displayed (e.g., as a bar chart) to do a side by side comparison per family category of the high priority vs moderate priority items within a family that need to be addressed.

A client can observe and quantify which NIST family tasks have greater high priority items for completion relative to low priority issues and how to effectively strategize compliance and resource allocation to comply with such items. For example, an NIST family task may possess many high priority remediation tasks but few low priority remediation tasks. Thus the client may decide to complete the high and low priority items for such task because they can receive a discount or by satisfying a high priority item, the same vendor may be able to also satisfy low priority items a la carte to better contain client costs. Therefore, clients can use the information displayed by visualization component 130 in a variety of pragmatic ways to accomplish its business, compliance and remediation goals. Also, each task can be associated with a particular task track category affiliation in various visual formats such as pie charts, graphs, etc. For instance, an NIST family can be categorized as any of a policy, tech, or process task track. Furthermore, a chart, such as a pie chart, can help a client understand what proportion of tasks fall under each particular task track.

Aside from NIST item breakdowns, visualization component 130 can also facilitate the visual depiction of HIPAA privacy or HIPAA breach data related to a client's business. In an aspect, the HIPAA privacy rules and regulations can be categorized (e.g. in a table format) by state and business unit (e.g., homecare, hospice, physician practice A, physician practice B, etc.) Furthermore, the HIPAA data can be itemized by regulation number and include corresponding established performance criteria in a scrollable table format such that the regulations are listed in column A and the described established performance criteria can be listed in column B. For example, column A can list regulation number 164.402 and column B can provide a synopsis or full description of the rule and/or regulation.

In another aspect, visualization component 130 can include charts that display HIPAA regulations (e.g., x-axis) and the number of items or client customers that violate or offend such regulation (e.g., y-axis). Thus, the client can observe trends of various issues and various regulations that are lacking compliance versus other such regulations. Also, in an aspect, the HIPPAA regulations can be depicted (e.g., using visualization component 130) in a manner (e.g., pie chart) that identifies of those client items that have been evaluated for HIPAA compliance, which are compliant (“met”), partially compliant (“partially met”), or non compliant (“not met”).

In another aspect, system 100 can employ sorting component 140 configured to sort, using the portal executing on the user device, a first subset of assessment information of the set of assessment information according to a set of desired assessment criteria corresponding to the first subset of assessment information and a first subset of remediation information of the set of remediation information based on a set of desired remediation criteria. As such, while visualization component 130 causes a graphical user interface to display various visualizations of compliance data, sorting component 140 facilitates the organization and sorting of the compliance data.

For instance, the host data (e.g., NIST data, HIPAA data) as compared to client data can result in assessed data (e.g., HIPAA compliance data and NIST compliance data) that a client seeks for further evaluation. As such, a client may desire to assess the data in various organizational or classification structures. Thus, the client can use sorting functions (linked to sorting algorithms and data structures) that facilitate the ordering of elements of the assessed compliance data in accordance with a client's desired evaluation criteria. Furthermore, the sort routines can be based on linking mechanisms between the compliance data such that logical nodes are interlinked to allow for easy searching and sorting of compliance data that is related to other such compliance data.

For instance, a HIPAA regulation that is defined by compliance criteria similar to another HIPAA regulation or requires completion of compliance tasks similar to another regulation, control, or procedure may allow for easy searching or aggregation of data sets associated with such compliance tasks and compliance criteria. The result is that clients can access the portal and effectively organize the data to be viewed and assessed in a myriad of ways. Therefore, NIST security status's can be sorted via NIST security family, HIPAA regulations can be sorted via HIPAA safeguard families, and other such sorting can be performed. Furthermore, in an aspect, the categorical sorting can be drilled down in a more detailed manner, where the client can view details related to the HIPAA safeguard family. For instance, if 30 administrative items are present in the administrative family, a user can then view what items are included in such family.

In an aspect, visualization component 130 can be configured to operate in association with sorting component 140. For instance, visualization component 130 can be configured to present compliance data related to assessed client data against host data, and such assessment results can be presented (e.g., using visualization component 130) to the user through a portal and on a graphical user interface. The visualization component 130 can display parameters associated with the assessed compliance data that are graphed in various ways (e.g., via tables, charts, graphics, etc.). The parameters can cover any information associated with the client data, host data, and assessed client and host data. Also, the sorting component 140 can facilitate the sorting of combined data points (e.g., host data points, client data points, compliance plan data points, remediation plan data points) and visualization component 130 can visualize the combined data points in a comprehendible manner such that the client 112 can visualize the compliance performance associated with the combined data points in the context of its objectives.

A client can utilize the information communicated in a graphical user interface to make an informed decision about the compliance plan and/or remediation plan of its business. For instance, the client user can implement new compliance procedures or reorganize its physical office setup to better comply with HIPAA regulations in light of information learned from the GUI as displayed by visualization component 130. In an aspect, the client can sort (e.g., using sorting component 140) the assessed data according to items that are partially meeting compliance within a particular NIST family. As a client sorts assessed compliance data, visualization component 140 can display the sorted data in various visual formats (e.g., pie charts, line graphs, tables, etc.).

Furthermore, in an aspect, client data is obtained and stored in a client database. The client data can then be associated with host data based on various assessment parameters (as defined by system 100). Accordingly, the various assessment parameters are utilized to compare the client data to the host data as pertains to client compliance plans and remediation plans. System 100 can then employ sorting component 140 to organize the data in various arrangements that make use of logical mapping based on connections between host data (e.g., HIPAA regulations integrated with other regulations or controls) and client data (e.g., items for compliance, location of compliance items, degree of vulnerability associated with each compliance item, remediation requirements, etc.).

In another aspect, system 100 can employ update component 150 configured to update, using the portal executing on the user device, the set of assessment information or the set of remediation information at a reoccurring time interval based on a set of updated assessment information or a set of updated remediation information respectively received by the system. In an aspect, client 112 and the service provider 114 may make recurring and/or continuous updates to the client compliance database 106 based on the ongoing implementation of the client compliance remediation plan 110.

Furthermore, host compliance database 104 receives recurring and/or continuous updates of host compliance data based on changes, additions, or revisions to host data (e.g., update to HIPAA regulations). These host compliance data updates may be facilitated through the service provider 114 and/or through other sources. Thus, due to the recurring and/or continuous updates (e.g., using update component 150), the provider processor 102 may continue to update (e.g., by employing update component 150) the client compliance plan 108 and the client compliance remediation plan 110.

The various updates (e.g., to the client database, host database, client compliance plan 108, client compliance remediation plan 110) facilitate the dynamic updating (e.g., using update component 150) of data and associated databases, which allows for the corresponding dynamism of visualization component 140 and sorting component 150 to accommodate updates (e.g., implemented using updated component 150). Thus, visualization component 140 can display updated data pertaining to various items such as newly complied with items, additional items requiring compliance, tracking the implementation of remediation efforts, completion of remediation tasks, acquisition of new locations that require compliance, and other such data updates. Accordingly, sorting component 140 can sort updated (e.g., using update component 150) data from updated databases and incorporate such new data, revised data, or removed data into the sorting, organizing, categorizing, and data mapping processes.

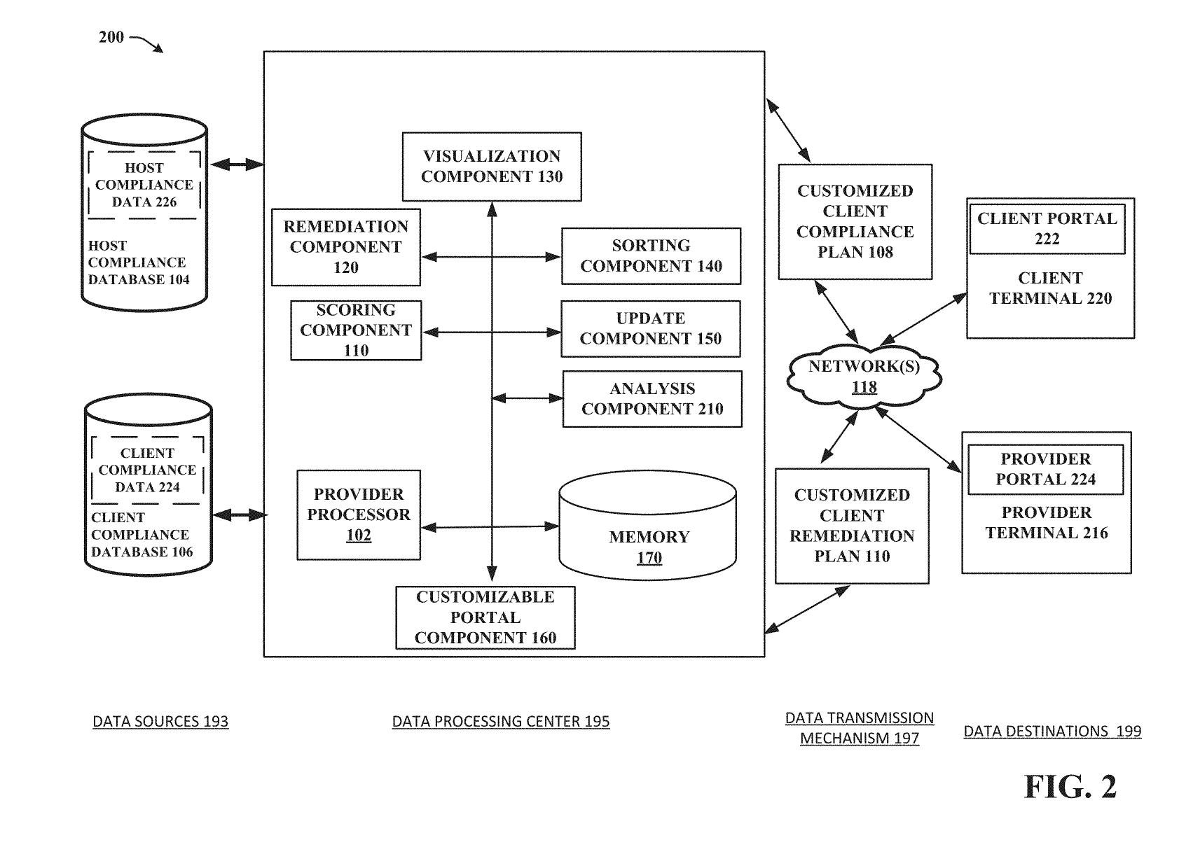

Turning now to FIG. 2, illustrated is system 200 comprising scoring component 110, remediation component 120, visualization component 130, sorting component 140, and update component 150. In another aspect, system 200 employs analysis component 210 that facilitates, using a portal executing on a user device, an analysis of the first subset of information, wherein the first subset of information represents federal regulatory requirement data, state regulatory requirement data, best practice compliance data, industry focused requirement data, demographic organized data, trending compliance data, historical compliance data, control rule data, privacy compliance requirement data, or security compliance regulatory data comprising any one or more of National Institute of Standards and Technology (NIST) requirement data, Health Insurance Portability and Accountability Act (HIPAA) requirement Data, International Organization for Standardization (IOS) requirement data, Payment Card Industry (PCI) requirement data, or Joint Commission on Accreditation of Healthcare Organizations (JCAHO) requirement data.

In an aspect, analysis component 210 facilitates analysis of various subsets of information including security, privacy and healthcare regulatory information. The analysis can include the facilitation of gathering information (e.g., NIST standards) generated by regulatory bodies and administrators (e.g., US Department of Commerce, NIST laboratories—IT Laboratory, NIST committee's, IOS, Payment Card Industry Security Standards Council, JCAHO, etc.) of various information. In an aspect, analysis component 210 can facilitate the generation of analytics and metrics derived from the gathered information and reported feedback about compliance patterns, remediation of compliance items, and satisfaction of compliance requirements. The feedback and analytics can be supplied (e.g., using visualization component 130) to interested parties (e.g., clients) to better tailor its compliance programs and planning to meet current and evolving standards.

In an aspect, the one or more processors in system 200 can employ analytics component 210 to log user traffic and interactions associated with compliance plans and generate analytics. Thus a client can view (e.g., using visualization component 130) analytical information to understand trends, compliance progressions, states of compliance, industry compliance and remediation information, and strategies to implement or not implement going forward as pertains to compliance. Embodiments of system 200 and analysis component 210 can operate within a communication framework such as the Internet, Intranet, or World-Wide-Web (“Web”). The embodiments can interact, responsive to user inputs, with a network-based data content hosting and delivery system, supported by network components such as servers linked by carious communication media, browsers, protocols including for example, Internet Protocol (IP) and hypertext transfer protocol (HTTP), web navigation tools such as Uniform Resource Locators (URL's), and the like.

In an aspect, a user (e.g., client) can interact with system 200 using a browser, at a portal within a client terminal, to supply input signals to an interface that a client interacts with. In response to the signals, components of system 200 including analysis component 210 can generate or produce report or visualization information (e.g., using visualization component 130). The visualization information of the analyzed data can communicate important information specific to a user-client. A provider provides outputs to the client relating to the creation and management of client compliance remediation plans and these outputs are analyzed and visualized for the client. The client 112 may receive analytics related to client compliance remediation plans 110 which may include assessment snapshots, risk profiles, peer reports, timeline schedules, online active plans, online active assessments as part of the client compliance remediation plan 110. The remediation plan may be prioritized and generated based on risk, impact, cost, feasibility and resources.

The assessment snapshot is a word document generated by the provider processor 102. Provider 114 may provide both an electronic and a hardcopy format of the assessment snapshot to client 112, with the electronic copy available through the client portal 222. The assessment snapshot furnishes a detailed analysis and summary of the security or compliance assessment provided by provider 114. Components of the assessment snapshot may include an Executive Summary, Environment Summary, Observations and Risk Assessment Results, Current Recommendations, Approach and Go Forward Plan, Policies, and a Gap report.

The Executive Summary may include an Overall summary, Current Compliance Summary Status, Covered Facilities, Current Enterprise Findings & Recommendations, Practice Findings and Recommendations, Compliance Dashboard, Summary of Work Performed, and Analysis Methodology. The Environment Summary may include an Environment Profile, Active Directory Security Profile, Single Sign-on Security Profile, and Electronic Health Records Profile.

The Observations and Risk Assessment Results may include a Meaningful Use Status, HIPAA Security Rule Status, Security Controls, Policy and Procedure mapping, Related Technology, Business Associate Management Status, and Contingency Planning and Emergency Operations. The Current recommendations, Approach and Go Forward Plan may include Current Recommendations, Recommendations Approach, a High Level Plan of Action and Milestone (POAM), and Recommended Compliance Process Going Forward. The Policies may include a list of missing required policies needed by the client to meet current compliance as determined by the provider processor 102.

The Gap Report may include a list of missing required items needed by the client to meet current compliance as determined by the provider processor 102. The Risk Profile and Peer Report may be included as part of the above-mentioned Compliance Dashboard. The Risk Profile is a summary of the client's current security and privacy risks generated by the provider processor 102. The Peer Report is a comparison of the client's security and privacy compliancy with other clients of similar type and size generated by the provider processor 102. The Regulation Scores are the final HIPAA Security Rule scoring generated by the provider processor 102 (e.g., employing scoring component 130). The Control Scores are the final Security Control scoring generated by the provider processor 102 (e.g., using scoring component 130). Thus, client remediation compliance plan 110 has many components and parts that facilitate a user to strategize implementing remediation strategies to more effectively comply with rules, regulations, policies, and processes.

In another aspect and in addition to the client remediation plan 110, the provider 114 can also guide client 112 in the remediation process and in updating the client compliance remediation plan 110. This iterative process involves provider 114 updating (e.g., using update component 150) the client compliance database 106 during remediation with new client compliance data 224 to allow re-assessment by provider processor 102.

All such provider activities, recommendation approach items, remediation compliance plan facets, and client activities can be graphically depicted (e.g., using visualization component 130) and are capable of conveying analytical information to clients and the provider. The analytical information can include initial data and information associated with raw policies (e.g., HIPAA policies), procedures, contracts and training of covered entities and its business associates who have access to PHI of the covered entity.

In an aspect, the initial data and information can be used to perform an initial review and raw scoring (e.g., using scoring component 110) is capable of being scored in association with client compliance data to form a client compliance database 106 capable of being accessed by provider processor 102. The initial raw scoring may include assigning a numerical value and/or rating the client compliance data 224 based on information available from the host compliance database 104. The analysis component 210 can generate analytics, metrics data, reports and visualizations (e.g., in connection with visualization component 130) related to the initial review, initial data, raw scores, numerical values, client compliance data and host compliance data. Furthermore, analysis component 210 can analyze, organize, perform computations on, perform look-ups or searches on, quantify, correlate sections of, make references based on, correlate sections of, filter, parse, classify (e.g., in connection with sorting component 140) the initial data and initial information.

The analytics or metrics data can reside in a computing device memory temporarily, for example, and subsequently stored for a longer term on a storage device such as disk storage, for example. In another aspect, analysis component 210 in connection with visualization component 210 can contribute to the generation of reports or visualizations associated with the data analytics that can reside in a computing device memory, temporarily, for example, and subsequently stored for a longer term on a storage device such as disk storage, for example. The visualizations can comprise a collection of analysis of particular statistics and analytics to allow for the further filtering (e.g., in connection with sorting component 140) or customization (e.g., using analysis component 210) of information in the reports or visualizations (e.g., formatted displays or documents in either tangible or electronic form).

In another aspect, analysis component 210 can provide analytics associated with technical client data and corresponding scores (e.g., using scoring component 110) including technical environment structures and conditions, vulnerability scans, technology tools, and configuration information of Covered Entities and their Business Associates who have access to PHI of the Covered Entity. Furthermore, in an aspect, analysis component 210 can provide analytics associated with physical client data and associated scores (e.g., using scoring component 110) including physical controls including location of screens, monitors, and access to secure areas of Covered Entities and their Business Associates who have access to protected health information of the Covered Entity.

Furthermore, in yet another aspect, analysis component 210 can provide analytics associated with process client data and associated scores (e.g., using scoring component 110) including current processes surrounding the collection, storage and transmission of Electronic Protected Health Information (EPHI) of Covered Entities and their Business Associates who have access to protected health information of the Covered Entity.

In an example based at least partly on client interactions with the portal, the client data, and the host data, the analysis component 210 can generate analytics relating to one or more compliance items, tasks, security matters, regulatory matter, control, process, or remediation item. Various metrics of interest can be generated based on the compliance items, such as statistics of the frequency of failing to comply with respective items, number of times particular vulnerabilities are exploited, number of times the client has revised various items in the compliance plan or remediation plan, and other such statistics.

Also, analysis component 210 can generate analytics associated with the data as well. For instance, a respective client can identify a number of times a particular data subset (e.g., representing a compliance task) has been changed, updated, revised (e.g., in light of new or altered regulations), and undergone any other such change. Analysis component 210 can make use of log info such as various data entries, log entries, log ID's, aggregated records to facilitate search, retrieval and analysis of various compliance and remediation items.

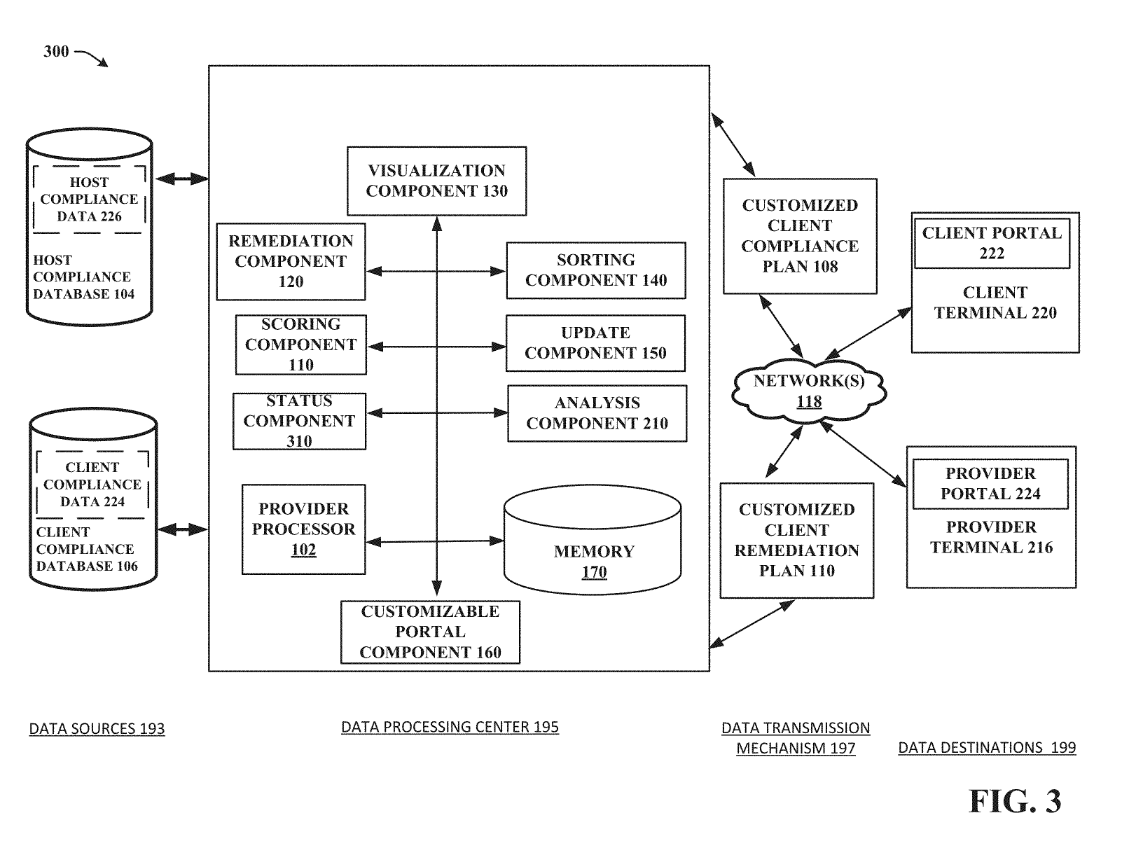

Turning now to FIG. 3, illustrated is system 300 comprising scoring component 110, remediation component 120, visualization component 130, sorting component 140, update component 150, and analysis component 210. In another aspect, system 300 employs status component 310 in connection with the graphical component 130 configured to indicate a status of an organizational state of compliance at a respective time. As disclosed herein, the state of compliance of the client can be dynamic due to changes in regulations, compliance mechanisms, remediation tasks, and other such factors. As such, the state of compliance can be reflected (e.g., using status component 310 in connection with visualization component 210) in real time by status component 310. In an aspect, the state of compliance 310 can be determined based on scores assigned to compliance items as compared to the client compliance database 106 and the client compliance plan. Accordingly, changes in the score can inform the state of compliance changes implemented by status component 310.

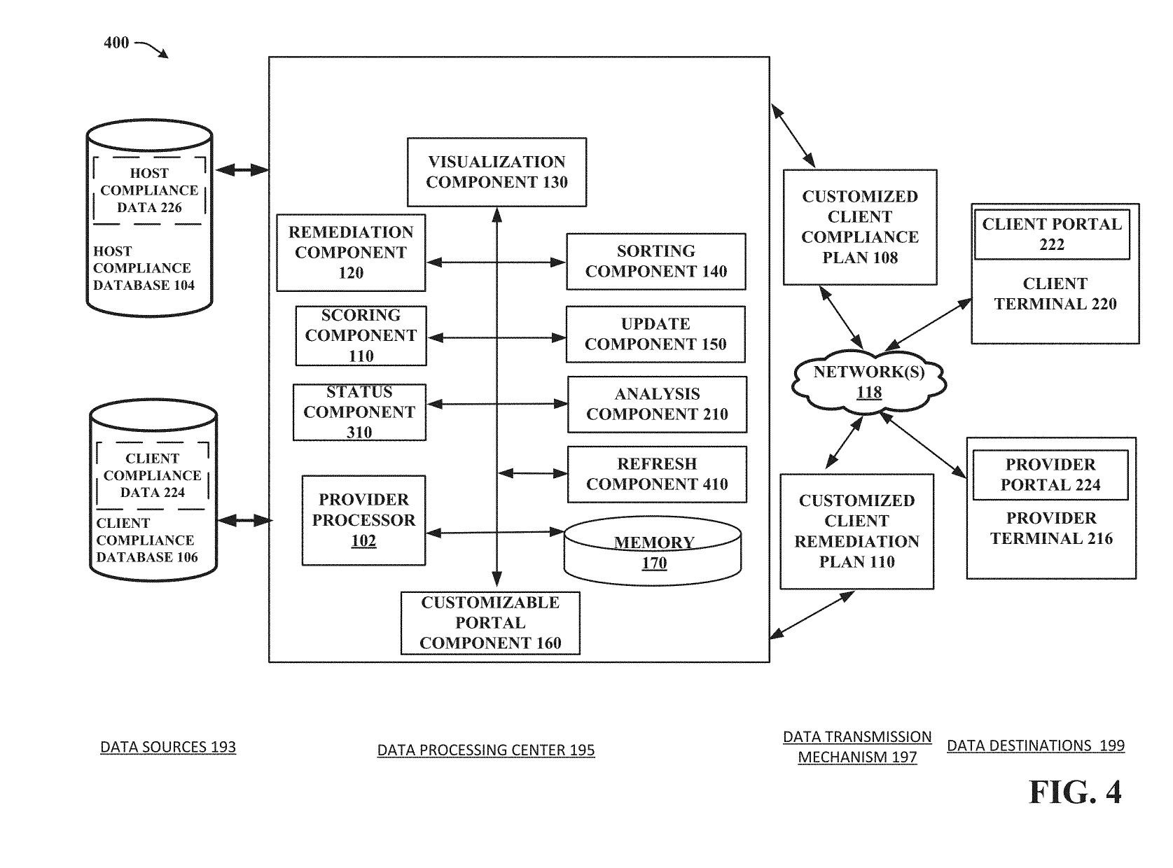

Turning now to FIG. 4, illustrated is system 400 comprising scoring component 110, remediation component 120, visualization component 130, sorting component 140, update component 150, analysis component 210, and status component 310. In another aspect, system 400 employs status refresh component 410 configured to update the status of the organizational state of compliance at a re-occurring time interval. As such the status determined using status component 310 can be updated on a frequently occurring basis by status refresh component 410 based on a pre-determined time interval.

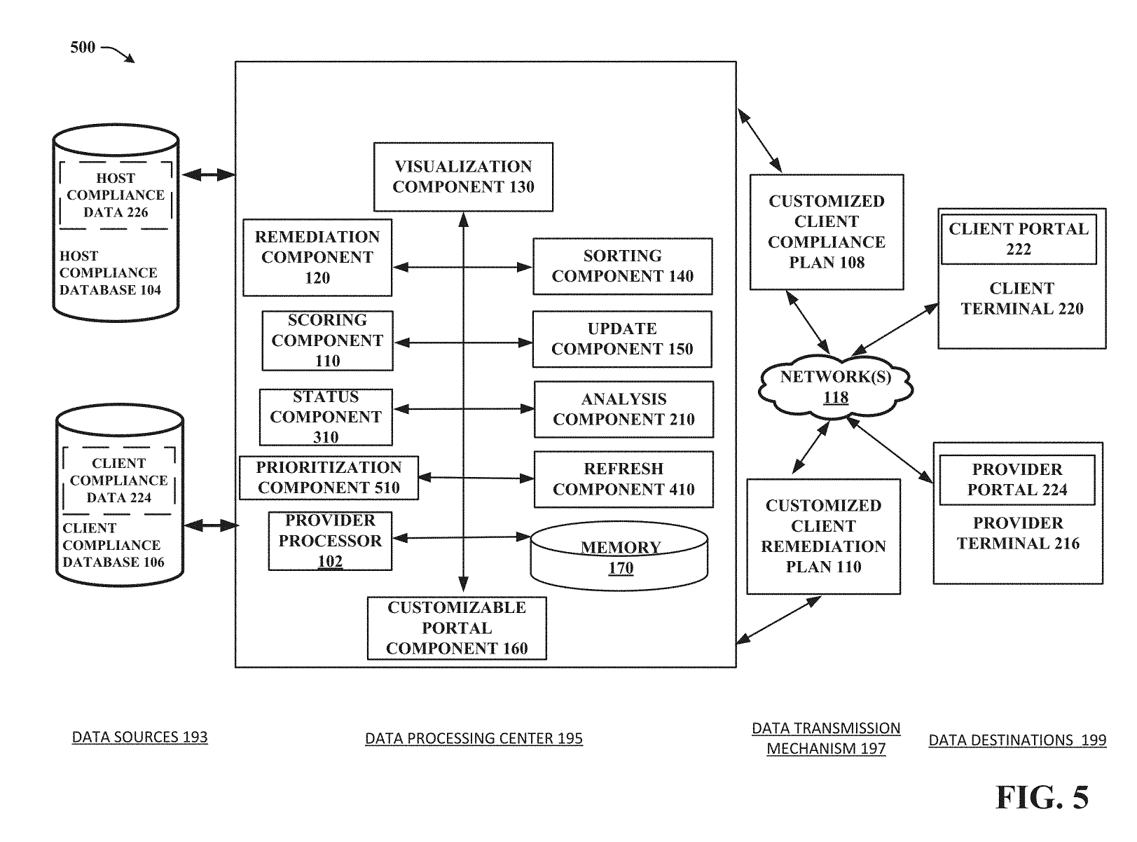

Turning now to FIG. 5, illustrated is system 500 comprising scoring component 110, remediation component 120, visualization component 130, sorting component 140, update component 150, analysis component 210, status component 310, and status refresh component 410. In another aspect, system 500 can employ prioritization component 510 configured to itemize a set of outstanding compliance tasks based on a level of priority. In an aspect, prioritization component 510 can generate a prioritized task list to guide the client in remediation. The prioritized task list can be included as part of the client compliance remediation plan 110 as an output.

Furthermore, other components of system 500 can be employed in connection with the prioritization component 510. For instance, scoring component 130 can score various tasks based on respective scoring and weighting metrics such that the tasks can be prioritized (e.g., using prioritization component 510) based on a consideration of pertinent priority metrics. For instance, tasks can be prioritized based on resource requirements necessary to fulfill the task. Furthermore, in an aspect, tasks can be prioritized based on a score generated by scoring component 110.

In another aspect, the client compliance remediation plan 110 may include an assessment snapshot, risk profile and peer report as well as a prioritized remediation plan and a timeline schedule. The prioritization component 510 can facilitate the prioritizing of items for remediation based on a number of factors including urgency of the compliance item for remediation, scope and/or scale of remediating the compliance item, resource requirement for remediating the compliance item, recommendations (e.g., from provider) or best practice guidance, duration of time to complete compliance task, scores (e.g., using scoring component 110) that reflect a degree of compliance already achieved within the task, a determination of how a sample population or pertinent industry (e.g., general popularity of the task for remediation) ranks the task for remediation, a determination (e.g., using a relevancy score by scoring component 110) of how each task relates to particular business goals and objectives of the client, and other such priority factors.

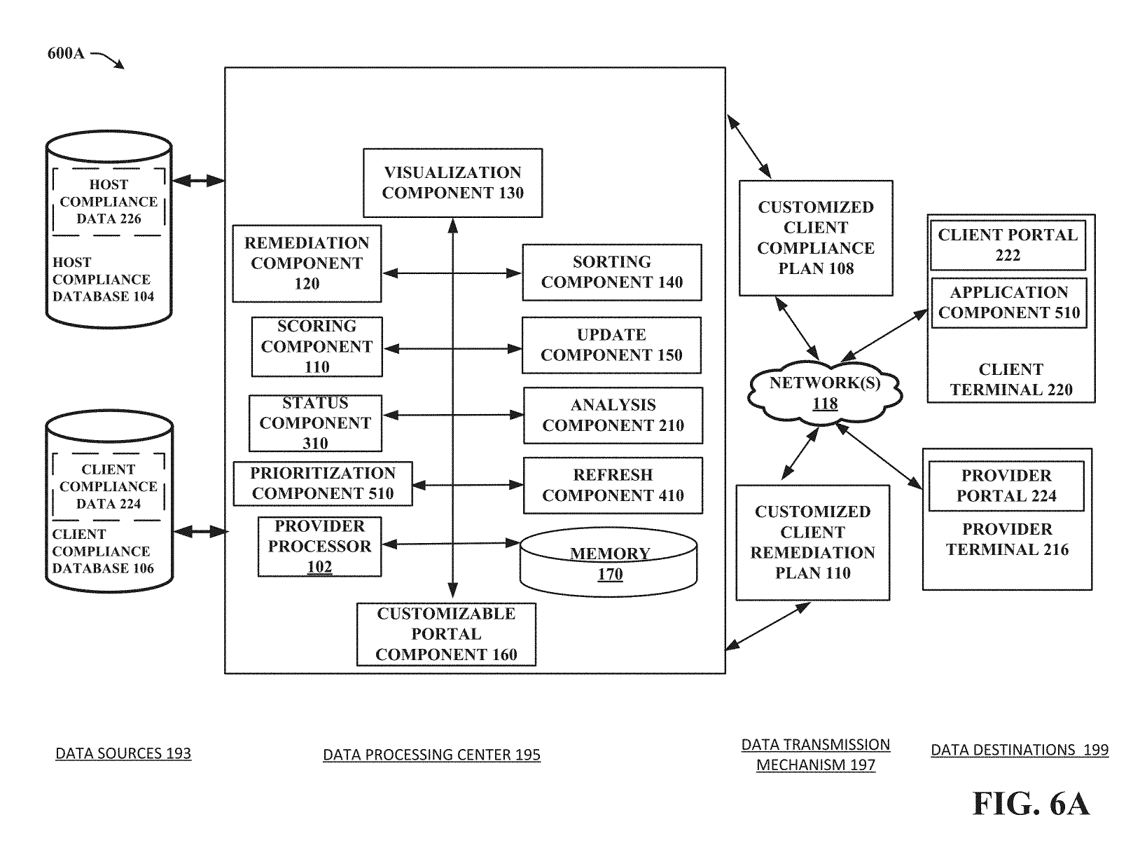

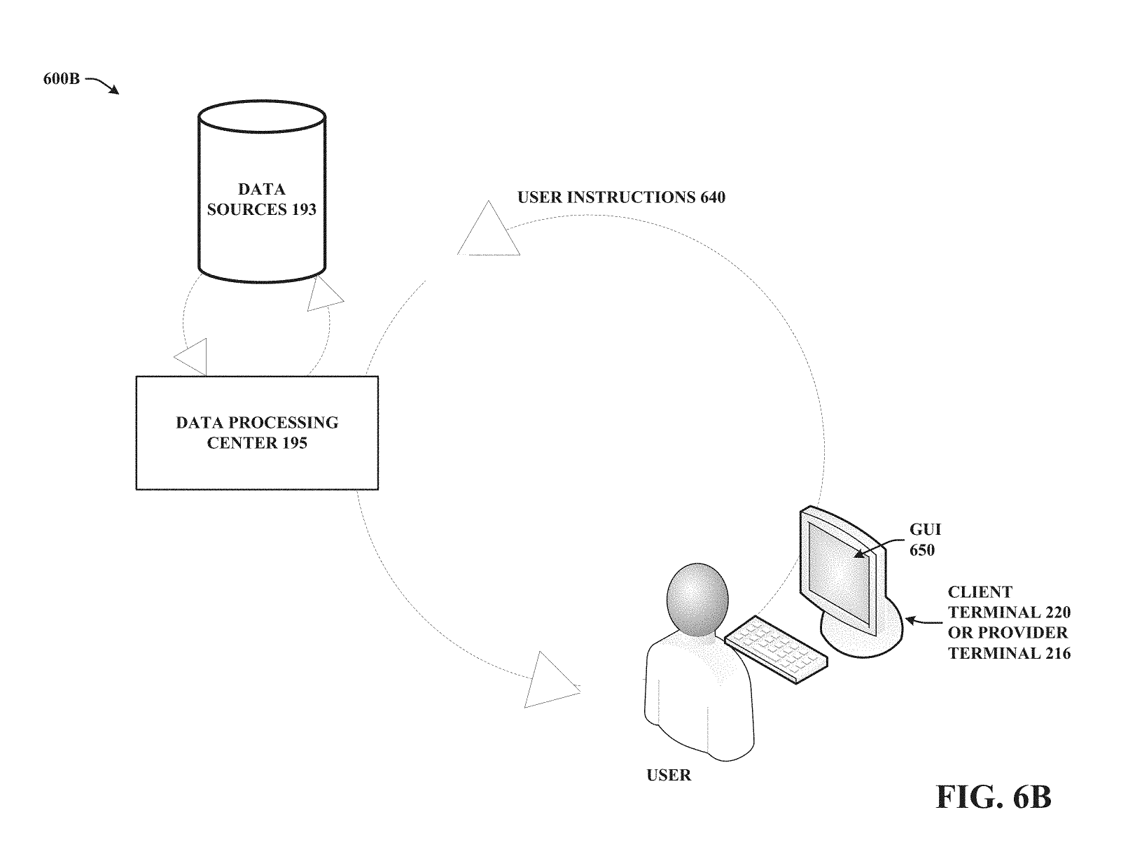

Turning now to FIG. 6A, illustrated is system 600A comprising scoring component 110, remediation component 120, visualization component 130, sorting component 140, update component 150, analysis component 210, status component 310, status refresh component 410, and prioritization component 510. In another aspect, system 600 can employ application component 610, configured to facilitate access to the portal using an application executing on a second user device. In an aspect, system 600A can be accessed through a portal on a terminal or via a variety of electronic devices. Furthermore, the portal can be configured to operate using application software compatible to operate on a mobile device or tablet. Thus access to system 600A can be facilitated through application software (e.g., using application component 610).

In an aspect, the application may be a stand-alone application, a website or other function of a web browser accessed over the Internet, or any other suitable application configuration. In an aspect, the application can share visualization (e.g., using visualization component 130) of the data with any other authorized application executing on other devices. The sharing of data amongst a client's organization facilitates participation of compliance activities amongst numerous relevant personnel in a user-friendly manner.

Turning now to FIG. 6B, illustrated is a recurring process of a compliance scenario between a client and a provider as well as the configurations that can be presented to the user (e.g., client or provider) on a graphical user interface (GUI). In an aspect, the recurring process can include the provider performing a compliance assessment on a client and making use of host data and client data. Based on the assessment, a plan can be created to achieve a better compliance status in light of client goals and the current state of the client. The assessment and compliance plan can be delivered to the client using an online active plan, a hardcopy and electronic assessment snapshot, or an online active assessment. Furthermore, the process to remediate the client compliance activities or non-compliant activities and updates to the compliance plan and remediation plan can be implemented. The implementation can be further reflected in another iteration of assessments, where the process is repeated.

Accordingly, using the online active plan, and online active assessment where various embodiments of data and depictions of compliance data and remediation data are communicated to a client using a GUI. In an aspect, presentation options of the compliance data and remediation data can be offered to the user as summary information, trend information, activity summarization, identification of compliance data points of interest, benchmarking data, data comparisons, data segmentation, and other such presentation options related to security and privacy compliance programs. As such, system architecture 600B illustrates the continuous updating process of the data sources 193 in connection with the continuous processing of updated data by data processing center 195 as well as the continuous access, management, and viewing of updated data by users at the provider or client terminal. Furthermore, the user can view the data in various graphical and text formats at a GUI on the terminal. The user can also send user instructions 640 to provide data updates to the data processing center 195 and data sources 193 based on the users continuing compliance and remediation activity.

In an aspect, various representations of data can be presented at a terminal GUI. For instance, at data can be represented graphically to present an NIST security status, a HIPAA Regulations status, a vulnerabilities to a client based on its compliance status, an NIST security family status, a HIPAA safeguard family status, and a vulnerability mitigation type status. Also, vulnerabilities can be depicted and subsets of vulnerability data associated with a client compliance status can be presented based on vulnerability severity, the mitigation type implemented, the occurrence and non-occurrence of vulnerability exploitation. In another aspect, the compliance data is represented in formats that communicate various locations with issues, the top NIST issues, detailed explanations of the issues, and top issue priority rankings. Furthermore, data representations can convey various compliance and remediation tasks of a client including a task group, a task priority, a task NIST family, and a task track. In yet another aspect, data representations can be associated with HIPAA privacy and HIPAA breaches, Top HIPAA regulations offenders, and items evaluated are depicted. All such data representations are non-limiting and can be included as part of a GUI communicating client compliance plans and remediation plans associated with security and privacy compliance regimes.

In various embodiments, computer program products having computer-readable mediums comprising code can be utilized to perform any of the methods and execute any of the system components described herein. The systems 100, 200, 300, 400, 500, 600A-B and/or the components of the system 100 can be employed to use hardware and/or software to solve problems that are highly technical in nature (e.g., related to scoring, remediating, visualizing, sorting, complying, etc.), that are not abstract and that cannot be performed as a set of mental acts by a human. Further, some of the processes performed may be performed by specialized computers for carrying out defined tasks related to the compliance, remediation, visualization/subject area. The systems 100-600A-B and/or components of the systems can be employed to solve new problems that arise through advancements in technology, computer networks, the Internet and the like. The systems 100-600A-B can provide technical improvements to compliance and remediation systems by improving visual depictions among processing components in a data visualization system, enhancing interaction and analysis of data associated with compliance and remediation systems in a data visualization system, communicating information and creating data points associated with compliance and remediation systems, and/or improving the utility of data in a compliance and remediation system, etc.

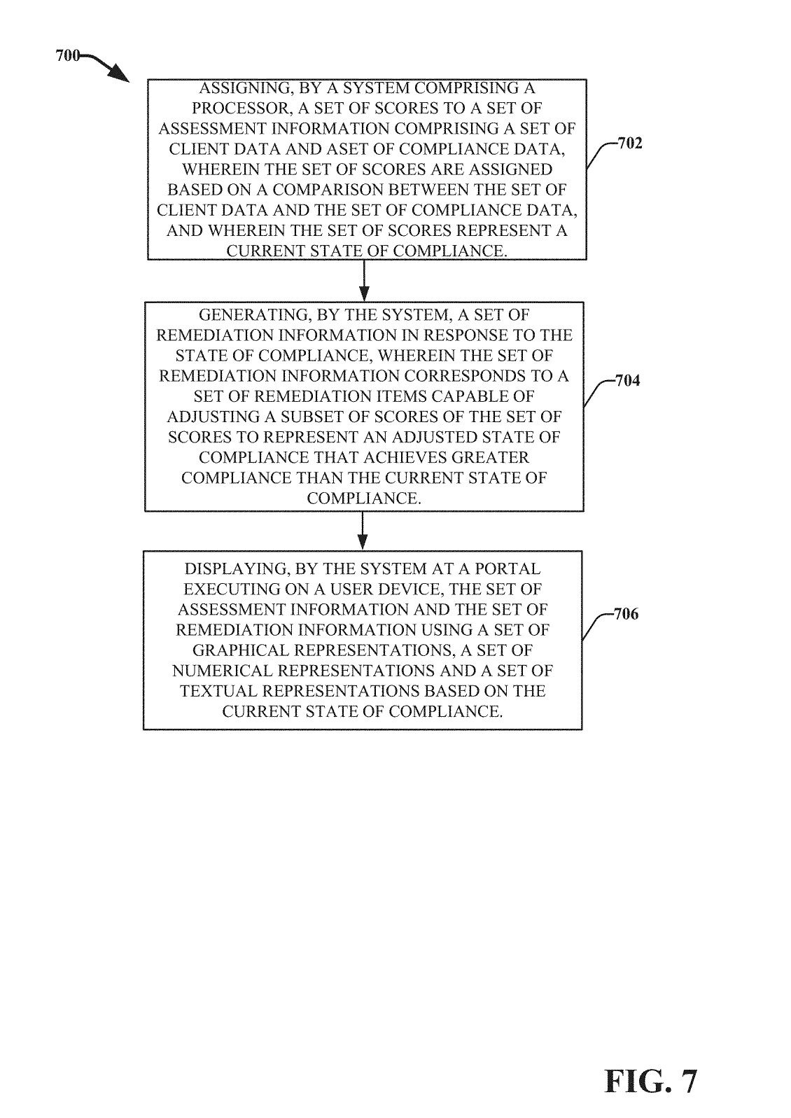

In view of the example systems and/or devices described herein, example methods that can be implemented in accordance with the disclosed subject matter can be further appreciated with reference to flowcharts in FIGS. 7-11. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein.

For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 7 illustrates a flow chart of an example method 700 for displaying visualizations of compliance data at an interface using a portal. At 702, a set of scores of assessment information comprising a set of client data and a set of compliance data is assigned by a system comprising a processor, where the set of scores are assigned based on a comparison between the set of organized client data and the set of compliance data, and wherein the set of scores represent a current state of compliance.

At 704, a set of remediation information is generated by the system in response to the state of compliance, wherein the set of remediation information corresponds to a set of remediation items capable of adjusting a subset of scores of the set of scores to represent an adjusted state of compliance that achieves greater compliance than the current state of compliance. At 706, the set of assessment information and the set of remediation information is displayed by the system using a set of graphical representations, a set of numerical representations and a set of textual representations based on the current state of compliance.

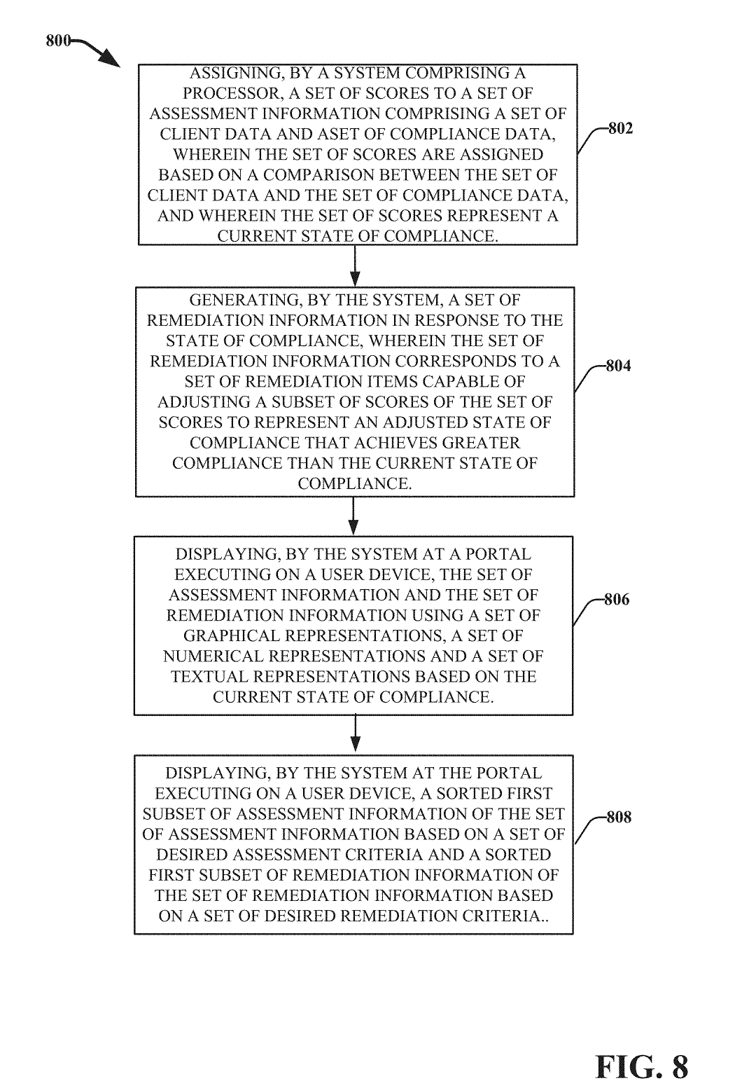

FIG. 8 illustrates a flow chart of an example method 800 for displaying visualizations of compliance data at an interface using a portal. At 802, a set of scores of assessment information comprising a set of client data and a set of compliance data is assigned by a system comprising a processor, where the set of scores are assigned based on a comparison between the set of organized client data and the set of compliance data, and wherein the set of scores represent a current state of compliance. At 804, a set of remediation information is generated by the system in response to the state of compliance, wherein the set of remediation information corresponds to a set of remediation items capable of adjusting a subset of scores of the set of scores to represent an adjusted state of compliance that achieves greater compliance than the current state of compliance.

At 806, a sorted subset of assessment information of the set of assessment information is displayed, by the system, at the portal executing on the user device based on a set of desired assessment criteria and a sorted first subset of remediation information of the set of remediation information based on a set of desired remediation criteria. At 808, the set of assessment information and the set of remediation information is displayed by the system using a set of graphical representations, a set of numerical representations and a set of textual representations based on the current state of compliance.

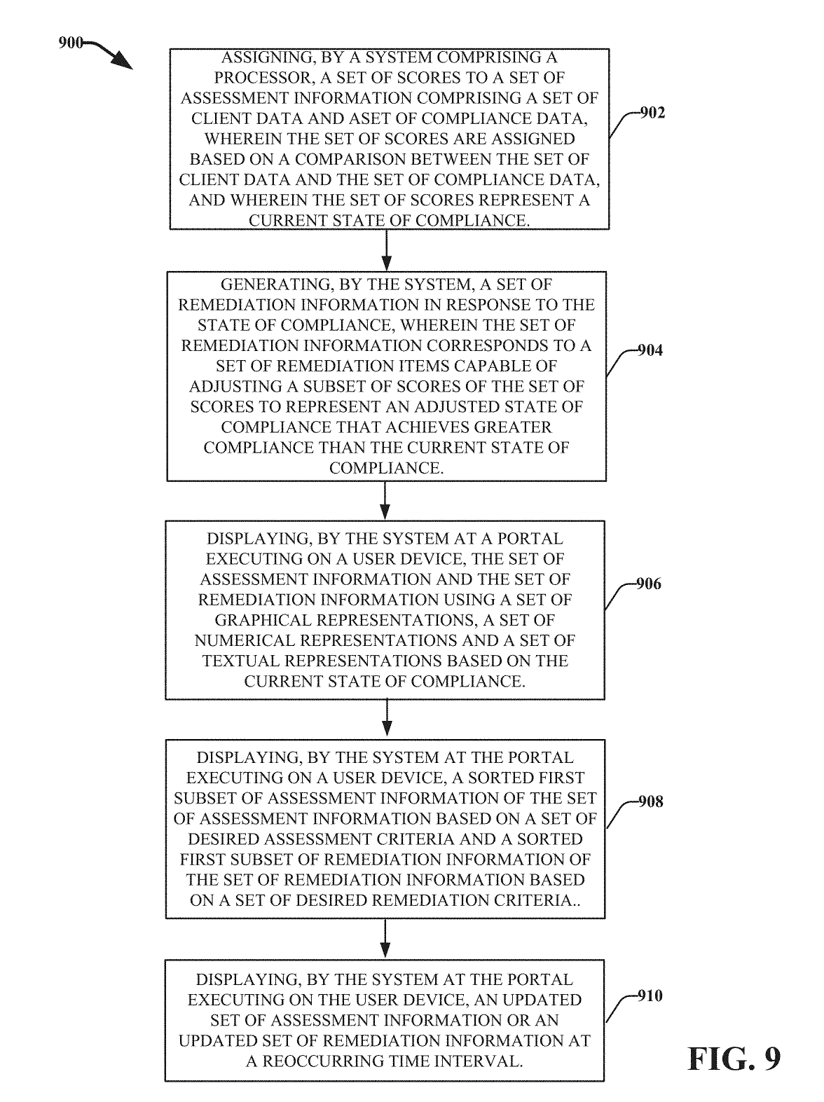

FIG. 9 illustrates a flow chart of an example method 900 for displaying visualizations of compliance data at an interface using a portal. At 902, a set of scores of assessment information comprising a set of client data and a set of compliance data is assigned by a system comprising a processor, where the set of scores are assigned based on a comparison between the set of organized client data and the set of compliance data, and wherein the set of scores represent a current state of compliance. At 904, a set of remediation information is generated by the system in response to the state of compliance, wherein the set of remediation information corresponds to a set of remediation items capable of adjusting a subset of scores of the set of scores to represent an adjusted state of compliance that achieves greater compliance than the current state of compliance.

At 906, a sorted subset of assessment information of the set of assessment information is displayed, by the system, at the portal executing on the user device based on a set of desired assessment criteria and a sorted first subset of remediation information of the set of remediation information based on a set of desired remediation criteria. At 908, the set of assessment information and the set of remediation information is displayed by the system using a set of graphical representations, a set of numerical representations and a set of textual representations based on the current state of compliance. At 910, an updated set of assessment information or an updated set of remediation information is displayed, by the system, at the portal executing on the user device at a reoccurring time interval.

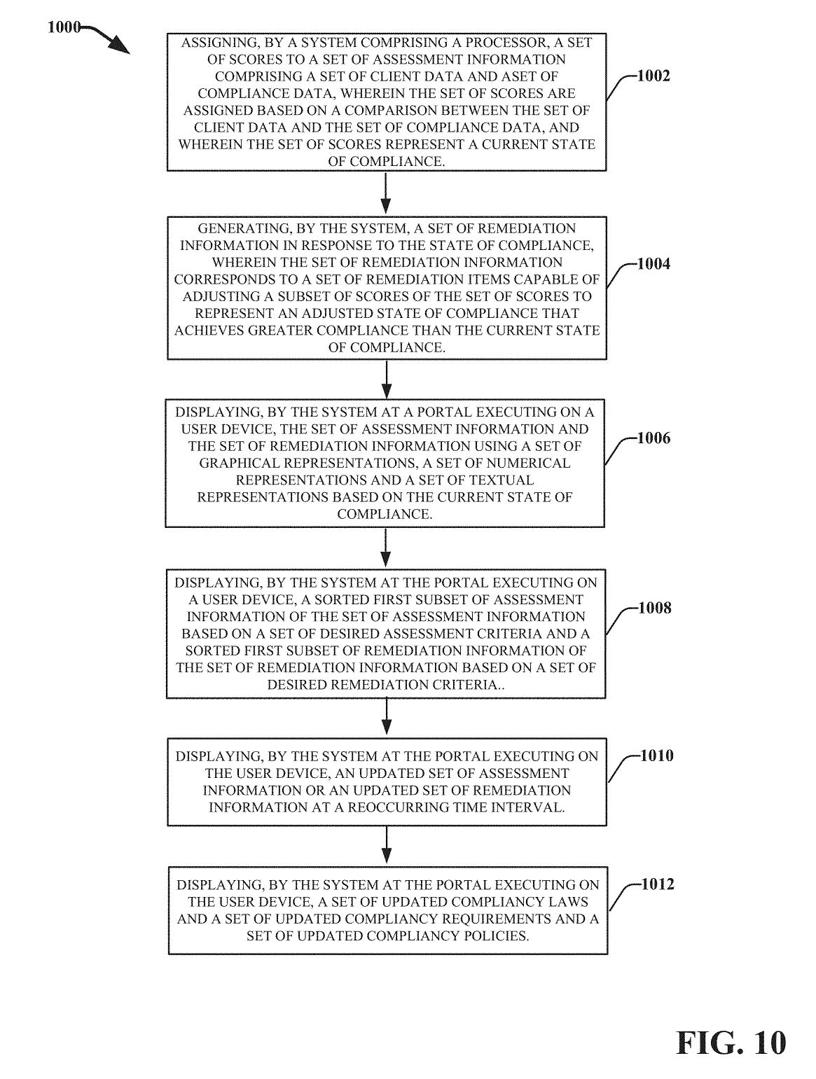

FIG. 10 illustrates a flow chart of an example method 1000 for displaying visualizations of compliance data at an interface using a portal. At 1002, a set of scores of assessment information comprising a set of client data and a set of compliance data is assigned by a system comprising a processor, where the set of scores are assigned based on a comparison between the set of organized client data and the set of compliance data, and wherein the set of scores represent a current state of compliance. At 1004, a set of remediation information is generated by the system in response to the state of compliance, wherein the set of remediation information corresponds to a set of remediation items capable of adjusting a subset of scores of the set of scores to represent an adjusted state of compliance that achieves greater compliance than the current state of compliance.

At 1006, a sorted subset of assessment information of the set of assessment information is displayed, by the system, at the portal executing on the user device based on a set of desired assessment criteria and a sorted first subset of remediation information of the set of remediation information based on a set of desired remediation criteria. At 1008, the set of assessment information and the set of remediation information is displayed by the system using a set of graphical representations, a set of numerical representations and a set of textual representations based on the current state of compliance. At 1010, a set of updated compliancy laws and a set of updated compliancy policies are displayed by the system at the portal executing on the user device. At 1012, an updated set of assessment information or an updated set of remediation information is displayed, by the system, at the portal executing on the user device at a reoccurring time interval.

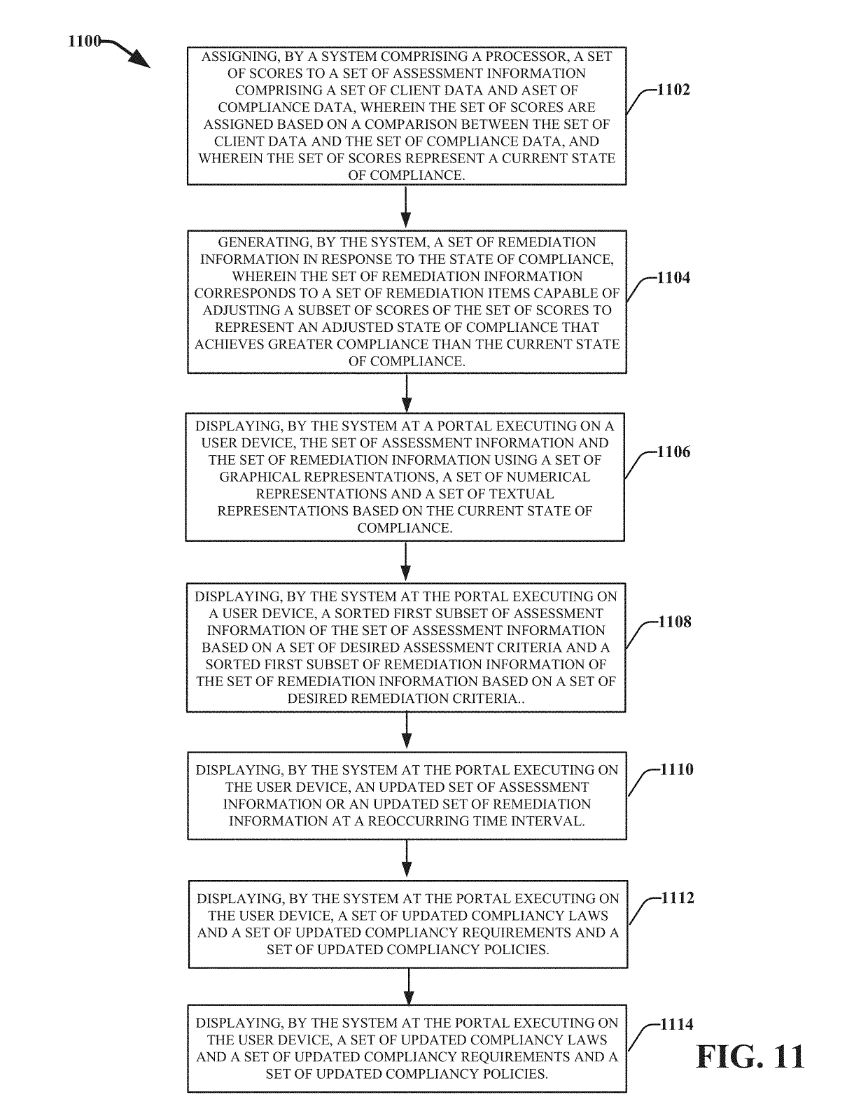

FIG. 11 illustrates a flow chart of an example method 1100 for displaying visualizations of compliance data at an interface using a portal. At 1102, a set of scores of assessment information comprising a set of client data and a set of compliance data is assigned by a system comprising a processor, where the set of scores are assigned based on a comparison between the set of organized client data and the set of compliance data, and wherein the set of scores represent a current state of compliance. At 1104, a set of remediation information is generated by the system in response to the state of compliance, wherein the set of remediation information corresponds to a set of remediation items capable of adjusting a subset of scores of the set of scores to represent an adjusted state of compliance that achieves greater compliance than the current state of compliance.

At 1106, a sorted subset of assessment information of the set of assessment information is displayed, by the system, at the portal executing on the user device based on a set of desired assessment criteria and a sorted first subset of remediation information of the set of remediation information based on a set of desired remediation criteria. At 1108, the set of assessment information and the set of remediation information is displayed by the system using a set of graphical representations, a set of numerical representations and a set of textual representations based on the current state of compliance. At 1110, a set of updated compliancy laws and a set of updated compliancy policies are displayed by the system at the portal executing on the user device. At 1112, the updated set of assessment information or the updated set of remediation information is reevaluating, by the system, at the portal executing on the user device. At 1114, a re-evaluated updated set of assessment information or a reevaluated updated set of remediation information is displayed, by the system, at the portal executing on the user device at a reoccurring time interval.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

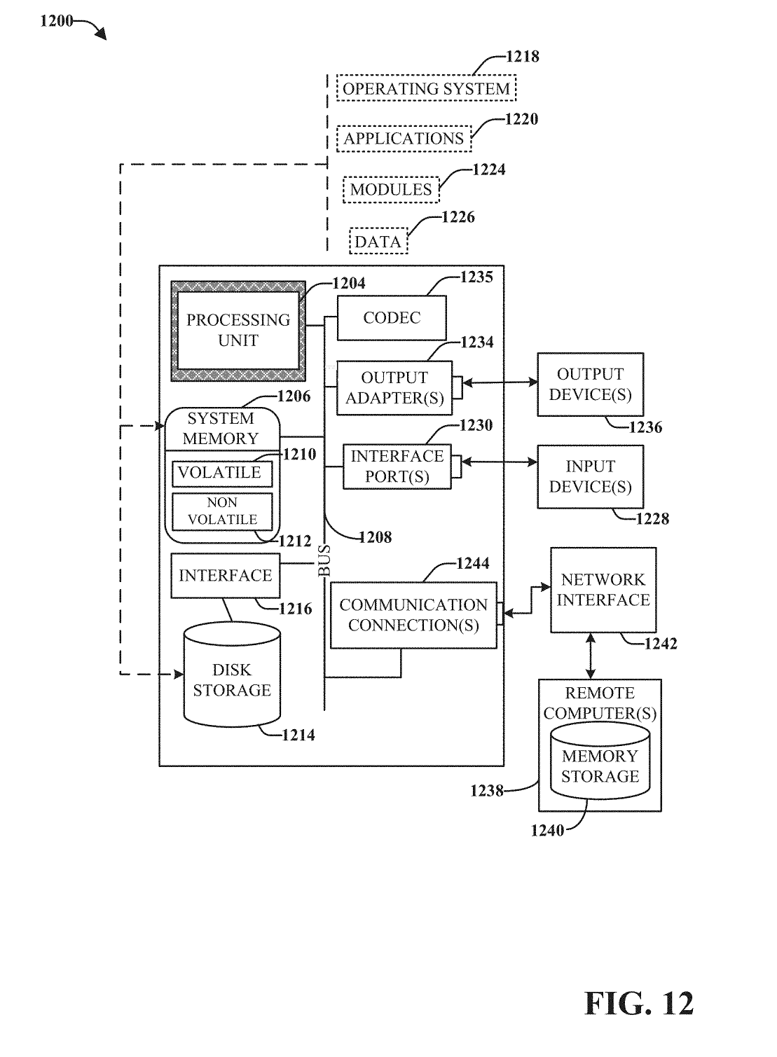

With reference to FIG. 12, a suitable environment 1200 for implementing various aspects of the claimed subject matter includes a computer 1202. The computer 1202 includes a processing unit 1204, a system memory 1206, a codec 1205, and a system bus 1208. The system bus 1208 couples system components including, but not limited to, the system memory 1206 to the processing unit 1204. The processing unit 1204 can be any of various available suitable processors. Dual microprocessors and other multiprocessor architectures also can be employed as the processing unit 1204.

The system bus 1208 can be any of several types of suitable bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 16104), and Small Computer Systems Interface (SCSI).

The system memory 1206 includes volatile memory 1210 and non-volatile memory 1212. The basic input/output system (BIOS), containing the basic routines to transfer information between elements within the computer 1202, such as during start-up, is stored in non-volatile memory 1212. In addition, according to present innovations, codec 1205 may include at least one of an encoder or decoder, wherein the at least one of an encoder or decoder may consist of hardware, a combination of hardware and software, or software. Although, codec 1205 is depicted as a separate component, codec 1205 may be contained within non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), or flash memory. Volatile memory 1210 includes random access memory (RAM), which acts as external cache memory. According to present aspects, the volatile memory may store the write operation retry logic (not shown in FIG. 12) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1202 may also include removable/non-removable, volatile/non-volatile computer storage medium. FIG. 12 illustrates, for example, disk storage 1214. Disk storage 1214 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1214 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1208, a removable or non-removable interface is typically used, such as interface 1216.

It is to be appreciated that FIG. 12 describes software that acts as an intermediary between users and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 1218 through program modules 1224, and program data 1226, such as the boot/shutdown transaction table and the like, stored either in system memory 1206 or on disk storage 1214. It is to be appreciated that the claimed subject matter can be implemented with various operating systems or combinations of operating systems.

A user enters commands or information into the computer 1202 through input device(s) 1228. Input devices 1228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same type of ports as input device(s). Thus, for example, a USB port may be used to provide input to computer 1202, and to output information from computer 1202 to an output device 1236. Output adapter 1234 is provided to illustrate that there are some output devices 1236 like monitors, speakers, and printers, among other output devices 1236, which require special adapters. The output adapters 1234 include, by way of illustration and not limitation, video and sound cards that provide a means of connection between the output device 1236 and the system bus 1208. It should be noted that other devices and/or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a server, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems and DSL modems, ISDN adapters, and wired and wireless Ethernet cards, hubs, and routers.

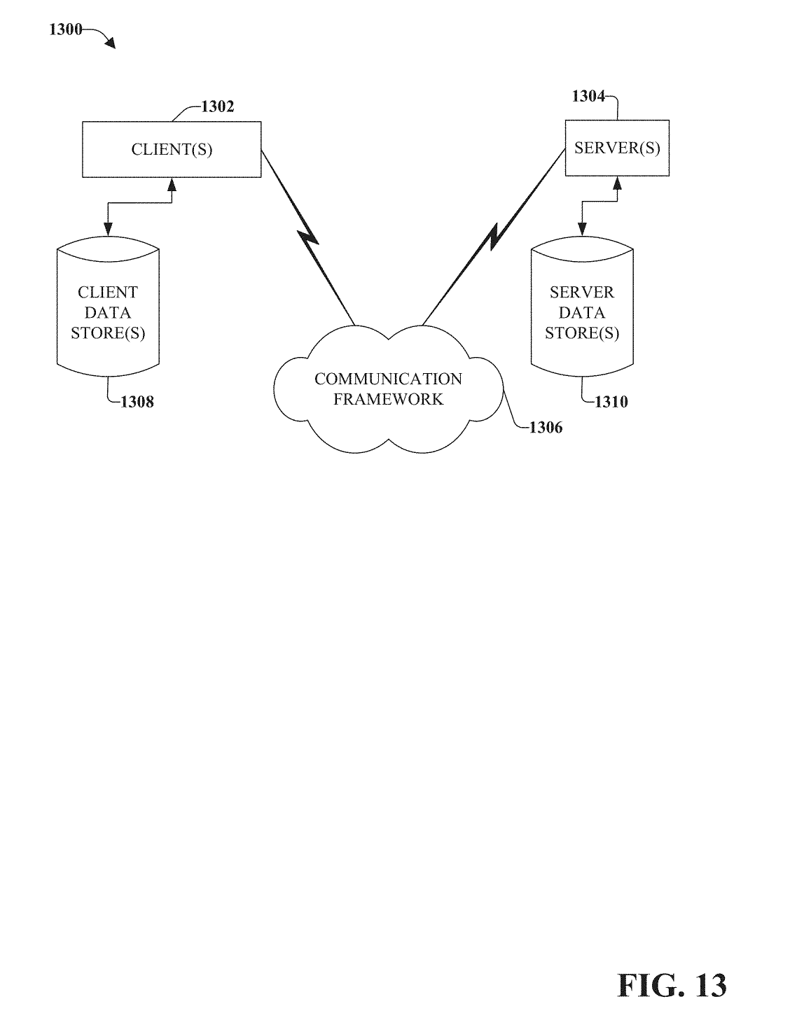

Referring now to FIG. 13, there is illustrated a schematic block diagram of a computing environment 1300 in accordance with this disclosure. The system 1300 includes one or more client(s) 1302 (e.g., laptops, smart phones, PDAs, media players, computers, portable electronic devices, tablets, and the like). The client(s) 1302 can be hardware and/or software (e.g., threads, processes, computing devices). The system 1300 also includes one or more server(s) 1304. The server(s) 1304 can also be hardware or hardware in combination with software (e.g., threads, processes, computing devices). The servers 1304 can house threads to perform transformations by employing aspects of this disclosure, for example. One possible communication between a client 1302 and a server 1304 can be in the form of a data packet transmitted between two or more computer processes wherein the data packet may include video data. The data packet can include a metadata, e.g., associated contextual information, for example. The system 1300 includes a communication framework 1306 (e.g., a global communication network such as the Internet, or mobile network(s)) that can be employed to facilitate communications between the client(s) 1302 and the server(s) 1304.

Communications can be facilitated via a wired (including optical fiber) and/or wireless technology. The client(s) 1302 include or are operatively connected to one or more client data store(s) 1308 that can be employed to store information local to the client(s) 1302 (e.g., associated contextual information). Similarly, the server(s) 1304 are operatively include or are operatively connected to one or more server data store(s) 1310 that can be employed to store information local to the servers 1304.

In one embodiment, a client 1302 can transfer an encoded file, in accordance with the disclosed subject matter, to server 1304. Server 1304 can store the file, decode the file, or transmit the file to another client 1302. It is to be appreciated, that a client 1302 can also transfer uncompressed file to a server 1304 and server 1304 can compress the file in accordance with the disclosed subject matter. Likewise, server 1304 can encode video information and transmit the information via communication framework 1306 to one or more clients 1302.

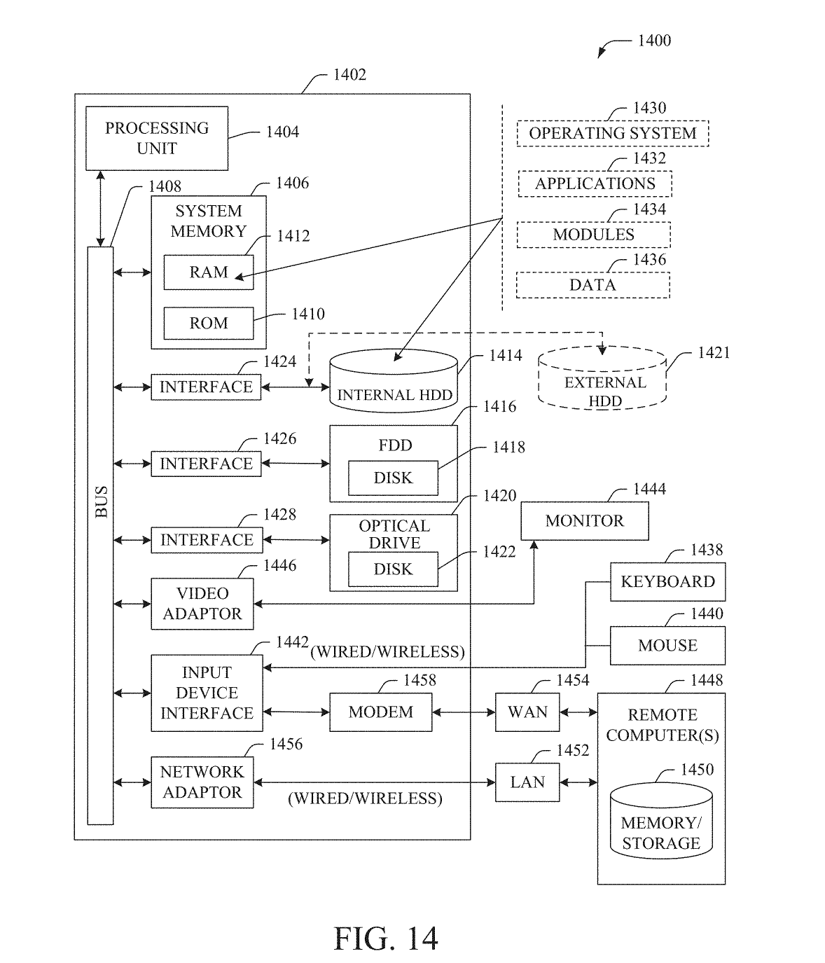

FIG. 14 illustrates a block diagram of a computer that can be employed in accordance with one or more embodiments. Repetitive description of like elements employed in other embodiments described herein is omitted for sake of brevity. In some embodiments, the computer, or a component of the computer, can be or be comprised within any number of components described herein comprising, but not limited to, management device 102, server devices 106, 108, 110, devices 122, 124 (or a component of management device 102, server devices 106, 108, 110, devices 122, 124).

In order to provide additional text for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules comprise routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable (or machine-readable) storage media and/or communications media, which two terms are used herein differently from one another as follows. Computer-readable (or machine-readable) storage media can be any available storage media that can be accessed by the computer (or a machine, device or apparatus) and comprises both volatile and nonvolatile media, removable and non-removable media. By way of example, and not limitation, computer-readable (or machine-readable) storage media can be implemented in connection with any method or technology for storage of information such as computer-readable (or machine-readable) instructions, program modules, structured data or unstructured data. Tangible and/or non-transitory computer-readable (or machine-readable) storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage, other magnetic storage devices and/or other media that can be used to store desired information. Computer-readable (or machine-readable) storage media can be accessed by one or more local or remote computing devices, e.g., via access requests, queries or other data retrieval protocols, for a variety of operations with respect to the information stored by the medium.

In this regard, the term “tangible” herein as applied to storage, memory or computer-readable (or machine-readable) media, is to be understood to exclude only propagating intangible signals per se as a modifier and does not relinquish coverage of all standard storage, memory or computer-readable (or machine-readable) media that are not only propagating intangible signals per se.

In this regard, the term “non-transitory” herein as applied to storage, memory or computer-readable (or machine-readable) media, is to be understood to exclude only propagating transitory signals per se as a modifier and does not relinquish coverage of all standard storage, memory or computer-readable (or machine-readable) media that are not only propagating transitory signals per se.

Communications media typically embody computer-readable (or machine-readable) instructions, data structures, program modules or other structured or unstructured data in a data signal such as a modulated data signal, e.g., a channel wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 14, the example environment 1400 for implementing various embodiments of the embodiments described herein comprises a computer 1402, the computer 1402 comprising a processing unit 1404, a system memory 1406 and a system bus 1408. The system bus 1408 couples system components comprising, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 comprises ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also comprise a high-speed RAM such as static RAM for caching data.

The computer 1402 further comprises an internal hard disk drive (HDD) 1410 (e.g., EIDE, SATA), which internal hard disk drive 1414 can also be configured for external use in a suitable chassis (not shown), a magnetic floppy disk drive 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface, respectively. The interface 1424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable (or machine-readable) storage media provide nonvolatile storage of data, data structures, computer-executable instructions, and so forth. For the computer 1402, the drives and storage media accommodate the storage of any data in a suitable digital format. Although the description of computer-readable (or machine-readable) storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1412, comprising an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

A communication device can enter commands and information into the computer 1402 through one or more wired/wireless input devices, e.g., a keyboard 1438 and a pointing device, such as a mouse 1440. Other input devices (not shown) can comprise a microphone, an infrared (IR) remote control, a joystick, a game pad, a stylus pen, touch screen or the like. These and other input devices are often connected to the processing unit 1404 through an input device interface 1442 that can be coupled to the system bus 1408, but can be connected by other interfaces, such as a parallel port, an IEEE 1394 serial port, a game port, a universal serial bus (USB) port, an IR interface, etc.

A monitor 1444 or other type of display device can be also connected to the system bus 1408 via an interface, such as a video adapter 1446. In addition to the monitor 1444, a computer typically comprises other peripheral output devices (not shown), such as speakers, printers, etc.

The computer 1402 can operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically comprises many or all of the elements described relative to the computer 1402, although, for purposes of brevity, only a memory/storage device 1450 is illustrated. The logical connections depicted comprise wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1452 through a wired and/or wireless communication network interface or adapter 1456. The adapter 1456 can facilitate wired or wireless communication to the LAN 1452, which can also comprise a wireless AP disposed thereon for communicating with the wireless adapter 1456.

When used in a WAN networking environment, the computer 1402 can comprise a modem 1458 or can be connected to a communications server on the WAN 1454 or has other means for establishing communications over the WAN 1454, such as by way of the Internet. The modem 1458, which can be internal or external and a wired or wireless device, can be connected to the system bus 1408 via the input device interface 1442. In a networked environment, program modules depicted relative to the computer 1402 or portions thereof, can be stored in the remote memory/storage device 1450. It will be appreciated that the network connections shown are example and other means of establishing a communications link between the computers can be used.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a defined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a femto cell device. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10 Base T wired Ethernet networks used in many offices.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of an acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a communication device desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing communication device behavior, operator preferences, historical information, receiving extrinsic information). For example, SVMs can be configured via a learning or training phase within a classifier constructor and feature selection module. Thus, the classifier(s) can be used to automatically learn and perform a number of functions, comprising but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of communication device equipment. A processor can also be implemented as a combination of computing processing units.

As used herein, terms such as “data storage,” “database,” and substantially any other information storage component relevant to operation and functionality of a component, refer to “memory components,” or entities embodied in a “memory” or components comprising the memory. It will be appreciated that the memory components or computer-readable (or machine-readable) storage media, described herein can be either volatile memory or nonvolatile memory or can comprise both volatile and nonvolatile memory.

Memory disclosed herein can comprise volatile memory or nonvolatile memory or can comprise both volatile and nonvolatile memory. By way of illustration, and not limitation, nonvolatile memory can comprise read only memory (ROM), programmable ROM (PROM), electrically programmable ROM (EPROM), electrically erasable PROM (EEPROM) or flash memory. Volatile memory can comprise random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to comprise, without being limited to, these and any other suitable types of memory.

What has been described above comprises mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “comprises” is used in either the detailed description or the claims, such term is intended to be inclusive in a manner similar to the term “comprising” as “comprising” is interpreted when employed as a transitional word in a claim.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from a computer-readable device or storage media.

What is claimed is:

1. A system comprising:
a memory that stores executable components; and
a processor, communicatively coupled to the memory, the processor configured to facilitate execution of the executable components, the executable components comprising:
a scoring component configured to assign a set of scores to a set of assessment information comprising a set of client data and a set of compliance data, wherein the set of scores are assigned based on a comparison between the set of client data and the set of compliance data, and wherein the set of scores represent a current state of compliance;
a remediation component configured to generate a set of remediation information in response to the state of compliance, wherein the set of remediation information corresponds to a set of remediation items capable of adjusting a subset of scores of the set of scores to represent an adjusted state of compliance that achieves an increased state of compliance as compared to the current state of compliance;
a visualization component configured to display, using a portal executing on a user device, the set of assessment information and the set of remediation information by a set of graphical depictions, a set of numerical depictions and a set of textual depictions based on the current state of compliance;
a sorting component configured to sort, using the portal executing on the user device, a first subset of assessment information of the set of assessment information according to a set of desired assessment criteria corresponding to the first subset of assessment information and a first subset of remediation information of the set of remediation information based on a set of desired remediation criteria; and
an update component configured to update, using the portal executing on the user device, the set of assessment information or the set of remediation information at a reoccurring time interval based on a set of updated assessment information or a set of updated remediation information respectively received by the system.

2. The system of claim 1, wherein the set of desired assessment criteria comprises any one or more of a risk profile of an assessment item, a peer report based on the assessment item, a regulatory compliance item, a regulatory control item, or a prioritized remediation item.

3. The system of claim 1, wherein the set of desired remediation criteria comprises any one or more of a risk associated with implementation of a remediation item, an impact associated with implementation of the remediation item, a cost associated with implementation of the remediation item, or a feasibility associated with implementation of the remediation item.

4. The system of claim 1, wherein the set of compliance data comprises a set of organizational best practice information, a set of regulatory controls, and a set of regulatory policies.

5. The system of claim 1, further comprising an analysis component that facilitates, using a portal executing on a user device, an analysis of the first subset of information, wherein the first subset of information represents federal regulatory requirement data, state regulatory requirement data, best practice compliance data, industry focused requirement data, control rule data, privacy compliance requirement data, or security compliance regulatory data comprising any one or more of National Institute of Standards and Technology requirement data, Health Insurance Portability and Accountability Act requirement Data, International Organization for Standardization requirement data, Payment Card Industry requirement data, or Joint Commission on Accreditation of Healthcare Organizations requirement data.

6. The system of claim 1, further comprising a status component in connection with the graphical component configured to indicate a status of an organizational state of compliance at a respective time.

7. The system of claim 6, further comprising a status refresh component configured to update the status of the organizational state of compliance at a re-occurring time interval.

8. The system of claim 1, further comprising a prioritization component configured to itemize a set of outstanding compliance tasks based on a level of priority.

9. The system of claim 1, further comprising an application component, configured to facilitate access to the portal using an application executing on a second user device.

10. The system of claim 1, wherein the set of graphical depictions, the set of numerical depictions or the set of textual depictions are capable of representing any one or more of a current security compliance status, a current privacy compliance status, a timeline schedule of remediation items for completion, an assessment snapshot of compliancy, an online active plan for achieving compliance, an ongoing assessment of the set of updated assessment information and the set of updated remediation information.

11. The system of claim 1, wherein the first subset of assessment information comprises any one of administrative flow data, technical flow data, physical flow data, or process flow data.

12. A method comprising,
assigning, by a system comprising a processor, a set of scores to a set of assessment information comprising a set of client data and a set of compliance data, wherein the set of scores are assigned based on a comparison between the set of client data and the set of compliance data, and wherein the set of scores represent a current state of compliance;
generating, by the system, a set of remediation information in response to the state of compliance, wherein the set of remediation information corresponds to a set of remediation items capable of adjusting a subset of scores of the set of scores to represent an adjusted state of compliance that achieves greater compliance than the current state of compliance; and
displaying, by the system at a portal executing on a user device, the set of assessment information and the set of remediation information using a set of graphical representations, a set of numerical representations and a set of textual representations based on the current state of compliance.

13. The method of claim 12, further comprising displaying, by the system at the portal executing on the user device, a sorted first subset of assessment information of the set of assessment information based on a set of desired assessment criteria and a sorted first subset of remediation information of the set of remediation information based on a set of desired remediation criteria.

14. The method of claim 12, further comprising displaying, by the system, at the portal executing on the user device an updated set of assessment information or an updated set of remediation information at a reoccurring time interval.

15. The method of claim 12, further comprising displaying, by the system, at the portal executing on the user device a set of updated compliancy requirements and a set of updated compliancy policies.

16. The method of claim 14, further comprising reevaluating, by the system, at the portal executing on the user device, the updated set of assessment information or the updated set of remediation information.

17. A method comprising,
accessing, using a portal executing on a user device, a privacy and security compliance management system configured to facilitate management of a set of compliance information representing an assessed state of compliance of an organization and a set of remediation information representing a remediation plan to increase the assessed state of compliance of the organization;
displaying, using the portal, the set of compliance information and a set of remediation information at the portal, wherein the set of compliance information and the set of remediation information is represented by graphical representations, mathematical representations, and textual representations; and
facilitating, using the portal, an analysis of the set of compliance information and the set of remediation information based on desired classification criteria.

18. The method of claim 18, further comprising evaluating, using the portal, a compliance level of an organization based on a set of organizational risk parameters comprising any one or more of an industry sector, an organizational size, a geographical location of an organization.

19. The method of claim 17, further comprising generating, using the portal, first compliancy scores corresponding to a first subset of compliance information representing security rules and controls, wherein the generating is based on a comparison of an organizational compliance plan to NIST references.

20. The method of claim 17, further comprising displaying, using the portal, remediation tools comprising any one or more of a dashboard, a prioritized task list, a remediation timeline, a reminder notification, a document library, or policy implementation guidance tools.
